(19) United States
(12) Patent Application Publication
(10) Pub. No.: US 2011/0286720 A1
(43) Pub. Date: Nov. 24, 2011

(54) ELECTRONIC APPARATUS, VIDEO PROCESSING METHOD, AND PROGRAM

(75) Inventors: Michimasa Obana, Tokyo (JP); Hiroshige Okamoto, Kanagawa (JP); Masashi Ota, Tokyo (JP)

(73) Assignee: Sony Corporation, Tokyo (JP)

(21) Appl. No.: 13/102,207

(22) Filed: May 6, 2011

(30) Foreign Application Priority Data
May 18, 2010 (JP) P2010-114048

(51) Int. Cl. H04N 5/783

(52) U.S. Cl. 386/343; 386/E05.003

(57) ABSTRACT

An electronic apparatus includes: a storage to store video data including a plurality of frames and feature frame information related to a feature frame including a predetermined video feature among the plurality of frames; a reproduction unit to reproduce the stored video data; an operation reception unit to receive a search operation of a user instructing to perform fast-forward or rewind of the reproduced video data at an arbitrary speed; and a controller to extract, when the search operation is received, a predetermined number of candidate frames from a frame at a time point the search operation is received, sort a plurality of frames between which the feature frame is not interposed from the candidate frames, extract a partial image from different parts of the plurality of sorted frames, generate a coupling frame by coupling the partial images in time series, and control to reproduce the coupling frame.

### BACKGROUND OF THE INVENTION

1. Field of the Invention

The present invention relates to an electronic apparatus capable of reproducing video data, and an image processing method and program in the electronic apparatus.

2. Description of the Related Art

From the past, electronic apparatuses such as a recording/reproducing apparatus are capable of performing processing for reproducing video data at a higher speed than a normal reproduction speed (fast-forward processing, search processing). In the fast-forward processing as described above, frames are thinned out according to the reproduction speed, and only a part of the frames are reproduced.

However, if the frames are thinned out in the fast-forward processing, all the frames become unable to be reproduced, with the result that important frames that are to be searched by a user may be overlooked, which is problematic.

In this regard, in a video data reproduction apparatus disclosed in Japanese Patent Translation Publication No. 99/45708 (hereinafter, referred to as Patent Document 1), at a time video data is output to an external apparatus as n (n>1)-fold speed video data, one frame of the output video is divided into n when n is an integer and divided into m (m is integer part of n) when n is not an integer, and a reproduction video is generated by allocating n frames or m frames of the video data to the one frame of the output video divided into n or m.

### SUMMARY OF THE INVENTION

However, in the technique disclosed in Patent Document 1, in a case where a video content largely changes due to, for example, a scene change among the n or m frames obtained by the division, uncorrelated images are coupled in the reproduction video, which makes it extremely unsightly for a user. Moreover, in such a reproduction video, it becomes difficult for a user to grasp a content of the scene.

In view of the circumstances as described above, there is a need for an electronic apparatus, an image processing method, and a program that are capable of preventing, when generating a fast-forward image by coupling images extracted from a plurality of frames, uncorrelated images from being coupled.

According to an embodiment of the present invention, there is provided an electronic apparatus including a storage, a reproduction unit, an operation reception unit, and a controller. The storage is configured to store video data including a plurality of frames and feature frame information related to a feature frame including a predetermined video feature among the plurality of frames. The reproduction unit is configured to reproduce the stored video data. The operation reception unit is configured to receive a search operation of a user that instructs to perform one of fast-forward and rewind of the reproduced video data at an arbitrary speed. The controller is configured to extract, when the search operation is received, a predetermined number of candidate frames from a frame at a time point the search operation is received, and sort a plurality of frames between which the feature frame is not interposed from the candidate frames. The controller is also configured to extract a partial image from each of different parts of the plurality of sorted frames, generate a coupling frame by coupling the partial images in time series, and control the reproduction unit to reproduce the coupling frame.

With this structure, the electronic apparatus can perform control so that, when generating a coupling frame to be reproduced at the time the search operation is made by coupling the partial images of the plurality of frames, the partial images are not extracted from the plurality of frames between which the feature frame is interposed. Therefore, the electronic apparatus can prevent partial images having uncorrelated video contents due to, for example, a scene change, from being coupled so that a coupling frame unsightly for a user and whose content is difficult to be understood is reproduced as the fast-forward image.

At least one of the plurality of frames may include an object image indicating an arbitrary object. In this case, the controller may re-sort the plurality of sorted frames so that the object image is not segmentalized by the extraction of the partial images.

With this structure, the electronic apparatus can prevent the content of the coupling frame from becoming difficult to be understood due to a single object being segmentalized by the extraction of the partial images.

The controller may calculate a degree of importance of each of a plurality of areas within each of the sorted frames, and re-sort the plurality of sorted frames so that the partial images are not extracted from the area having the degree of importance smaller than a predetermined threshold value out of the areas within each frame.

With this structure, since the electronic apparatus can generate a coupling frame by coupling parts of the frames having a high degree of importance, it becomes possible to prevent important information from being overlooked and make a user accurately grasp the content of the video as the search operation target.

The areas may be obtained by dividing each frame based on a plurality of ranges of distance from a center of each frame. In this case, the degree of importance may be set to become higher as the distance from the center to each area in each frame becomes smaller.

With this structure, the electronic apparatus can generate a coupling frame using partial images close to the center of the frames. Here, the reason why the degree of importance is set higher as the distance from the center of each frame becomes smaller is because the possibility that an image important for a user may be included becomes higher as it gets closer to the center and it is also noticeable for a user during reproduction of the coupling frame.

The areas may be obtained by dividing each frame based on an object detected from each frame. In this case, the degree of importance may be set to become higher as a size of the object detected from each frame becomes larger.

With this structure, since the electronic apparatus can generate the coupling frame using large objects included in the frames as partial images, the objects become noticeable for a user when the coupling frame is reproduced.

The storage may store importance degree information indicating a degree of importance of each object that the object image represents. In this case, the controller may recognize the object that the object image represents from the sorted frames. The controller may also re-sort, based on the stored importance degree information, the plurality of sorted frames so that the object image indicating the object having the degree of importance that is equal to or higher than a predetermined threshold value out of the recognized objects is included in the partial images.

With this structure, by re-sorting the frames after judging the degree of importance of each object, the electronic apparatus can incorporate an important object in the coupling frame. Here, the object refers to, for example, a face and body (excluding face) of a human being, and the face of a human being is set with a higher degree of importance than the body.

In this case, the controller may re-sort, in a case where a first object image included in a first frame out of a plurality of sorted frames is not included in the coupling frame upon re-sorting the plurality of sorted frames so that a second object image included in a second frame out of the plurality of sorted frames is not segmentalized by the extraction of the partial images, the plurality of sorted frames so that an object image indicating an object having a high degree of importance out of a first object represented by the first object image and a second object represented by the second object image is included in the coupling frame.

With this structure, by sorting the frames such that the object having a high degree of importance is incorporated in the coupling frame while allowing the object having a low degree of importance to be segmentalized, the electronic apparatus can prevent information important for a user from being overlooked when the coupling frame is reproduced.

The controller may execute predetermined image processing for simplifying an image within the partial images, that corresponds to an image of an area excluding an area within a predetermined range from a center of the coupling frame and an area having the degree of importance that is equal to or higher than the predetermined threshold value, out of the coupling frames to be generated from the partial images extracted from the plurality of sorted frames.

With this structure, by simplifying parts of images having a low degree of importance for a user, the electronic apparatus can make the part having a high degree of importance to stand out when the coupling frame is reproduced. Here, examples of the image processing for the simplification include airbrushing processing, color deletion processing, and substitute processing to other pixel values such as black.

In this case, the controller may reduce the area within the predetermined range as the speed of one of the fast-forward and the rewind increases.

With this structure, by enlarging the range of the area to be simplified when a fast-forward speed is high, the electronic apparatus can make the important part of the coupling frame noticeable. This processing is based on the presupposition that a user's observing point tends to center at the center of the coupling frame as the fast-forward speed increases.

The controller may cause two of the partial images to be coupled to overlap by a predetermined amount of area, and couple the partial images by extracting pixels from the predetermined amount of area of each of the two partial images at a predetermined rate.

With this structure, by smoothly coupling the partial images of the frames and making the boundaries thereof inconspicuous, the electronic apparatus can enhance visibility of the coupling frame.

The controller may generate a coupling frame to be reproduced subsequent to the reproduced coupling frame based on the predetermined number of candidate frames that are extracted from frames that start with the frame right after the feature frame.

With this structure, since the electronic apparatus can use the candidate frames that have not been used for generating the previously-reproduced coupling frame, for generating the next coupling frame, frames that are not used for generating a coupling frame are prevented from being generated, with the result that it becomes possible to prevent a user from overlooking a specific video during the search operation.

According to another embodiment of the present invention, there is provided an image processing method including storing video data including a plurality of frames and feature frame information related to a feature frame including a predetermined video feature among the plurality of frames. The stored video data is reproduced. A search operation of a user that instructs to perform one of fast-forward and rewind of the reproduced video data at an arbitrary speed is received. When the search operation is received, a predetermined number of candidate frames are extracted from a frame at a time point the search operation is received. A plurality of frames between which the feature frame is not interposed are sorted from the candidate frames. A partial image is extracted from each of different parts of the plurality of sorted frames. A coupling frame is generated by coupling the partial images in time series, and the coupling frame is reproduced.

According to another embodiment of the present invention, there is provided a program that causes an electronic apparatus to execute the steps of: storing video data including a plurality of frames and feature frame information related to a feature frame including a predetermined video feature among the plurality of frames; reproducing the stored video data; receiving a search operation of a user that instructs to perform one of fast-forward and rewind of the reproduced video data at an arbitrary speed; extracting, when the search operation is received, a predetermined number of candidate frames from a frame at a time point the search operation is received; sorting a plurality of frames between which the feature frame is not interposed from the candidate frames; extracting a partial image from each of different parts of the plurality of sorted frames; generating a coupling frame by coupling the partial images in time series; and reproducing the coupling frame.

As described above, according to the embodiments of the present invention, it is possible to prevent, when generating a fast-forward image by coupling images extracted from a plurality of frames, uncorrelated images from being coupled.

These and other objects, features and advantages of the present invention will become more apparent in light of the following detailed description of best mode embodiments thereof, as illustrated in the accompanying drawings.

### BRIEF DESCRIPTION OF DRAWINGS

FIG. 1 is a diagram showing a hardware structure of a PVR (Personal Video Recorder) according to an embodiment of the present invention;

FIG. 2 is a diagram showing functional blocks of software of the PVR according to the embodiment of the present invention;

FIG. 3 is a flowchart showing a rough flow of coupling image display processing carried out by the PVR according to the embodiment of the present invention;

FIG. 4 is a flowchart showing a flow of strip parameter determination processing according to the embodiment of the present invention;

FIG. 5 are diagrams showing a brief overview of two methods of determining a start position of an input frame according to the embodiment of the present invention;

FIG. 6 is a diagram showing an example of parameters that are determined in the embodiment of the present invention;

FIG. 7 is a diagram showing an example of an original image and an output image (coupling image) in a case where a search speed is 8 times the normal speed in the embodiment of the present invention;

FIG. 8 is a diagram showing an example of an original image and an output image (coupling image) in a case where the search speed is 15 times the normal speed in the embodiment of the present invention;

FIG. 9 is a diagram showing an example of an original image and an output image (coupling image) in a case where the search speed is 5 times the normal speed in the embodiment of the present invention;

FIG. 10 is a diagram showing an example of an original image and an output image (coupling image) in a case where the search speed is 15 times the normal speed in the embodiment of the present invention;

FIG. 11 is a flowchart showing a flow of image feature judgment processing and image area processing according to the embodiment of the present invention;

FIG. 12 is a diagram showing an example of the image area processing according to the embodiment of the present invention;

FIG. 13 is a diagram showing other examples of the image area processing according to the embodiment of the present invention;

FIG. 14 is a block diagram showing details of a strip frame sorting unit according to the embodiment of the present invention;

FIG. 15 is a flowchart showing a flow of strip frame sorting processing according to the embodiment of the present invention;

FIG. 16 is a diagram schematically showing an overall flow of the strip frame sorting processing according to the embodiment of the present invention;

FIG. 17 is a diagram schematically showing the sorting processing (1) of the strip frame sorting processing according to the embodiment of the present invention;

FIG. 18 is a diagram schematically showing the sorting processing (2) of the strip frame sorting processing according to the embodiment of the present invention;

FIG. 19 is a diagram schematically showing the sorting processing (3) of the strip frame sorting processing according to the embodiment of the present invention;

FIG. 20 is a flowchart showing a flow of strip cutout processing according to the embodiment of the present invention;

FIG. 21 is a flowchart showing a flow of strip image processing according to the embodiment of the present invention;

FIG. 22 are diagrams schematically showing the strip image processing according to the embodiment of the present invention;

FIG. 23 is a flowchart showing a flow of strip coupling processing according to the embodiment of the present invention;

FIG. 24 is a diagram schematically showing an example of a method of the strip coupling processing according to the embodiment of the present invention;

FIG. 25 is a diagram schematically showing another example of the method of the strip coupling processing according to the embodiment of the present invention;

FIG. 26 is a diagram showing functional blocks of software of a PVR according to another embodiment of the present invention;

FIG. 27 is a flowchart showing a flow of stereoscopic view processing according to another embodiment of the present invention;

FIG. 28 are diagrams showing conditions of objects that are processed in the stereoscopic view processing according to another embodiment of the present invention; and

FIG. 29 are diagrams schematically showing examples of the stereoscopic view processing according to another embodiment of the present invention.

### DESCRIPTION OF PREFERRED EMBODIMENTS

Hereinafter, embodiments of the present invention will be described with reference to the drawings.

### (Hardware Structure of PVR)

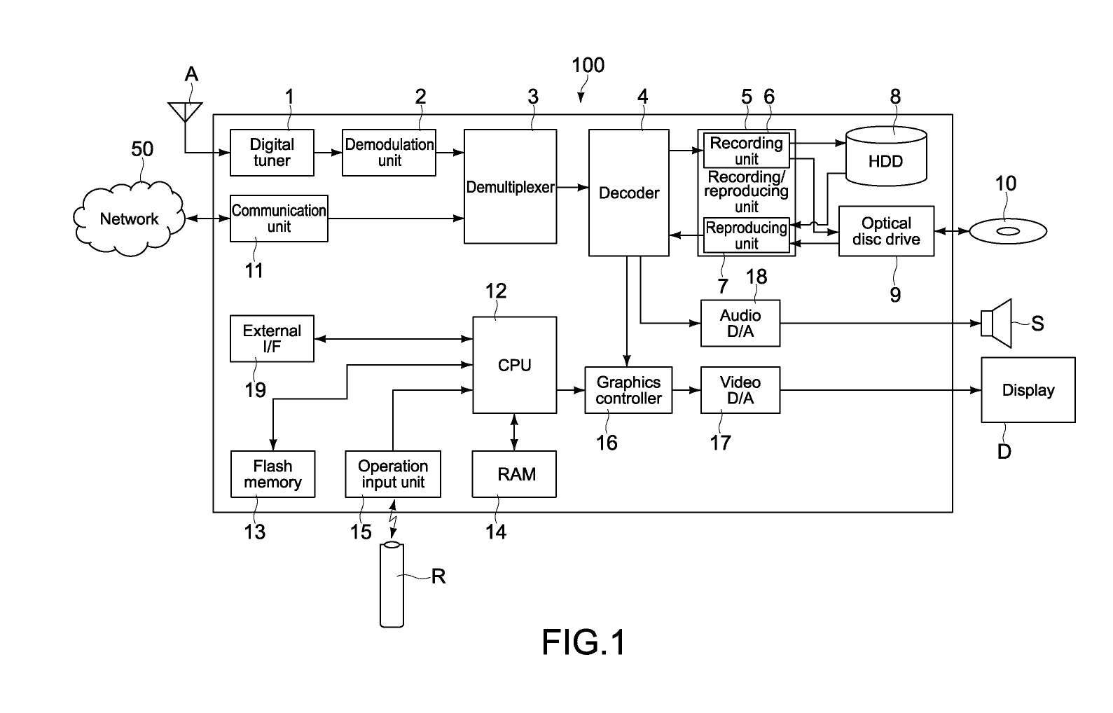

FIG. 1 is a diagram showing a hardware structure of a PVR (Personal Video Recorder) according to an embodiment of the present invention.

As shown in the figure, a PVR 100 includes a digital tuner 1, a demodulation unit 2, a demultiplexer 3, a decoder 4, a recording/reproducing unit 5, an HDD (Hard Disk Drive) 8, an optical disc drive 9, and a communication unit 11. The PVR 100 also includes a CPU (Central Processing Unit) 12, a flash memory 13, and a RAM (Random Access Memory) 14. The PVR 100 also includes an operation input unit 15, a graphics controller 16, a video D/A (Digital/Analog) converter 17, an audio D/A (Digital/Analog) converter 18, and an external interface 19.

The digital tuner 1 selects a specific digital broadcast channel via an antenna A under control of the CPU 12 and receives broadcast signals including program data. The broadcast signals are in a format of, for example, an MPEG stream encoded by an MPEG-2 TS format (TS: Transport Stream), though not limited to this format. The demodulation unit 2 demodulates the modulated broadcast signals.

The demultiplexer 3 splits the multiplexed broadcast signals into a video signal, an audio signal, a subtitle signal, an SI (Service Information) signal, and the like and supplies them to the decoder 4.

The decoder 4 decodes the video signal, audio signal, subtitle signal, and SI signal split by the demultiplexer 3. The decoded signals are supplied to the recording/reproducing unit 5.

The recording/reproducing unit 5 includes a recording unit 6 and a reproducing unit 7. The recording unit 6 temporarily stores the video signal and audio signal decoded and input by the decoder 4 and outputs and records the signals to/on the HDD 8 and the optical disc drive 9 while controlling timings and data amounts. The recording unit 6 is also capable of reading out contents recorded in the HDD 8, outputting them to the optical disc drive 9, and recording them on an optical disc 10. The reproducing unit 7 reads out video and audio signals of a video content recorded in/on the HDD 8 and the optical disc 10 and outputs the signals to the decoder 4 while controlling timings and data amounts to thus reproduce the signals.

The HDD 8 stores contents such as video data of programs received via the digital tuner 1, various types of video data received by the communication unit 11 via a network 50, and video data taken by a user in a built-in hard disk. When reproducing the stored contents, the HDD 8 reads out the data from the hard disk and outputs the data to the recording/reproducing unit 5.

The HDD 8 stores various programs and other data in some cases. The programs and data are read out from the HDD 8 in response to a command from the CPU 12 at a time the programs and data are executed and a time they are referenced and developed in the RAM 14.

Similar to the HDD 8, the optical disc drive 9 is capable of recording various types of data such as the program content onto the mounted optical disc 10 and reading out the recorded data. Moreover, the various programs may be recorded onto a portable recording medium such as the optical disc 10 and installed in the PVR 100 by the optical disc drive 9. Examples of the optical disc 10 include a BD (Blu-ray Disc), a DVD (Digital Versatile Disc), and a CD (Compact Disc).

The communication unit 11 is a network interface for exchanging data with other apparatuses on the network 50 based on a protocol such as TCP/IP (Transmission Control Protocol/Internet Protocol) by connecting with the network 50. When the data received by the communication unit 11 is multiplexed, the data is supplied to the demultiplexer 3.

The external interface 19 is constituted of, for example, a USB interface, an HDMI (High-Definition Multimedia Interface), or a memory card interface, and connects with a photographing apparatus such as a digital video camera and a digital still camera, a memory card, and the like to read out video data taken by a user.

The CPU 12 accesses the RAM 14 and the like as necessary and collectively controls processing of blocks of the PVR 100. As will be described later, the PVR 100 of this embodiment is capable of generating a coupling image by cutting out strip-like partial images (hereinafter, referred to as strip images) from each frame of a content (video data) and coupling the plurality of strip images, and reproducing the coupling image when a high-speed search (fast-forward/rewind) operation is made by a user. In addition to video data reception processing, the CPU 12 controls the blocks in generation processing of the coupling image.

Here, the high-speed search operation is an operation of a predetermined number of times the normal speed or more, such as 5 times the normal speed, though not limited thereto. When a search operation smaller than the predetermined number of times the normal speed is made, the frames are merely displayed at a speed corresponding to the search operation.

The flash memory 13 is, for example, a NAND-type nonvolatile memory that fixedly stores firmware such as an OS, programs, and various parameters that are executed by the CPU 12. The flash memory 13 also stores software such as a video reproduction application having the coupling image generation function described above and various types of data requisite for such an operation.

The RAM 14 is a memory that is used as a working area of the CPU 12 and the like and temporarily stores the OS, programs, processing data, and the like during the reproduction processing of video data, the coupling image generation processing, and the like.

The operation input unit 15 receives inputs of various setting values and commands corresponding to a user operation such as the search operation from a remote controller R including a plurality of keys, for example. The operation input unit 15 may of course be constituted of a keyboard and a mouse connected to the PVR 100, a switch, a touch panel, and a touchpad mounted to the PVR 100, and the like that do not use the remote controller R.

The graphics controller 16 carries out graphics processing such as OSD (On Screen Display) processing on video signals output from the decoder 4 and other video data output from the CPU 12 and generates a video signal for displaying the processed signal on a display D of a television apparatus (hereinafter, referred to as TV) or the like.

The video D/A converter 17 converts a digital video signal input from the graphics controller 16 into an analog video signal and outputs it to the display D of the TV or the like via a video output terminal and the like.

The audio D/A converter 18 converts a digital audio signal input from the decoder 4 into an analog audio signal and outputs it to a speaker S of the TV or the like via an audio output terminal and the like.

### (Software Structure of PVR)

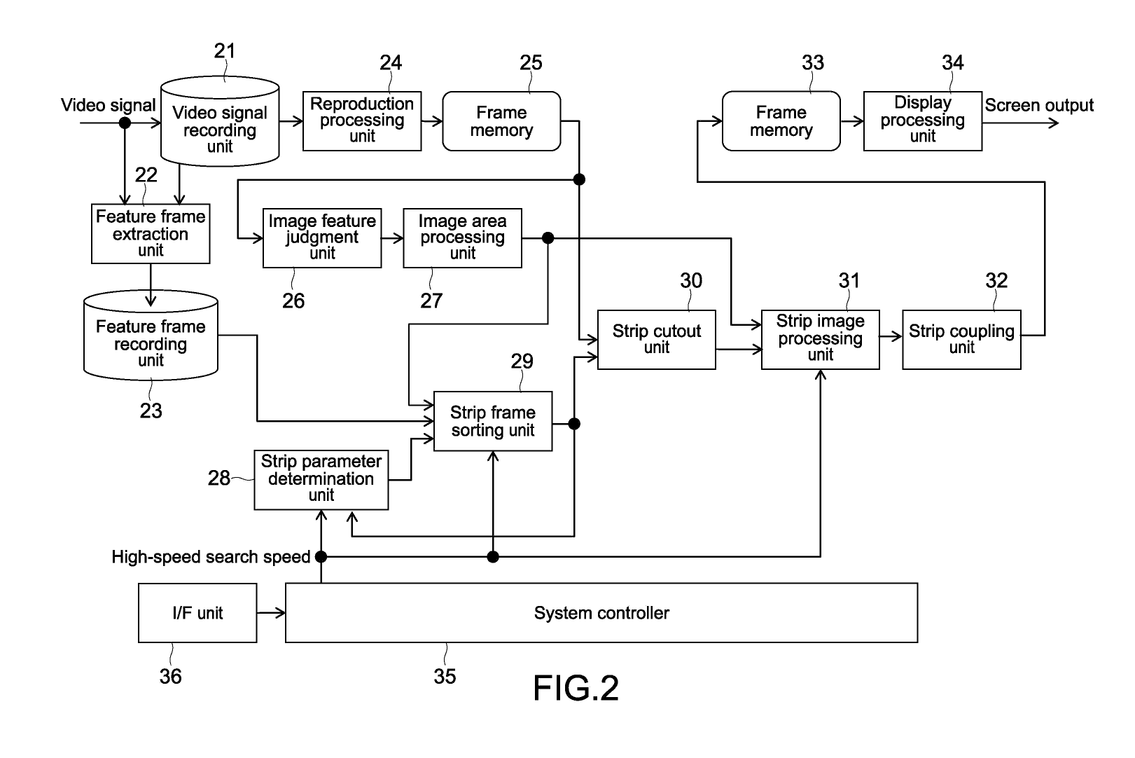

FIG. 2 is a diagram showing functional blocks of software of the PVR 100 for carrying out strip coupling processing.

As shown in the figure, the PVR 100 includes a video signal recording unit 21, a feature frame extraction unit 22, a feature frame recording unit 23, a reproduction processing unit 24, a frame memory 25, an image feature judgment unit 26, an image area processing unit 27, a strip parameter determination unit 28, a strip frame sorting unit 29, a strip cutout unit 30, a strip image processing unit 31, a strip coupling unit 32, a frame memory 33, a display processing unit 34, a system controller 35, and an I/F unit 36.

The video signal recording unit 21 records video signals of contents such as a broadcast program received by the digital tuner 1, video data received by the communication unit 11, and video data input by the external interface 19.

The feature frame extraction unit 22 extracts a feature frame from a content recorded by the video signal recording unit 21 or a content input to the PVR 100 but not yet recorded by the video signal recording unit 21. The feature frame is a frame indicating a scene change such as a cut point and an intermediate point of a fade zone. The feature frame extraction processing may be executed right after a content is recorded by the video signal recording unit 21 or may be executed periodically after being recorded.

The feature frame recording unit 23 records the feature frame extracted by the feature frame extraction unit 22.

The reproduction processing unit 24 reads out the content from the video signal recording unit 21 and reproduces (decodes) it.

The frame memory 25 temporarily buffers a frame of the content reproduced by the reproduction processing unit 24.

The image feature judgment unit 26 judges whether the frames stored in the frame memory 25 include an image of an object that may cause an adverse effect when the strip coupling processing to be described later is carried out, and outputs the judgment result to the image area processing unit 27. Here, the object includes, in addition to a tangible entity such as a face and body of a human being, an animal, and a building, a variable character area such as a telop.

The image area processing unit 27 divides all the input frames from which strip images to be described later are cut out into a plurality of areas, ranks the areas obtained by the division based on a degree of importance, and outputs the rank information to the strip image processing unit 31. Here, the areas obtained by the division include areas that are divided in strips according to a distance from a center of the frame and areas divided based on a shape of an object in the frame.

The strip parameter determination unit 28 determines parameters requisite for strip frame sorting processing to be described later and subsequent processing based on a search speed of the search operation made by the user, and outputs the parameters to the strip frame sorting unit 29. Here, the parameters include the number of times the same output image is displayed, the number of thin-out frames, and a type of a target picture among the input frames.

Further, the strip parameter determination unit 28 inputs a result of the strip frame sorting processing carried out by the strip frame sorting unit 29 to be described later and determines an input frame position for generating the next output image. The input frame position determination processing breaks into two types of processing depending on whether the frame right after the feature frame is to be used as an input frame for generating the next coupling image upon receiving the processing result of the strip frame sorting unit 29. Details thereof will be described later.

The strip frame sorting unit 29 uses the feature frame extracted by the feature frame extraction unit 22, the rank information output by the image area processing unit 27, the parameter determined by the strip parameter determination unit 28, and the search speed of the search operation made by the user to additionally optimize a strip-base frame according to the parameter determined by the strip parameter determination unit 28 and determine a final frame to be a strip base. The result of determining the strip-base frame is output to the strip parameter determination unit 28 and the strip cutout unit 30. Although details will be given later, the strip frame sorting processing is separated into processing that uses time (position) information including feature frame information, processing that uses an in-frame feature, and processing that uses an inter-frame feature.

According to the sorting information of the strip frame sorting unit 29, the strip cutout unit 30 cuts out image data in strips from a plurality of frames and outputs them to the strip image processing unit 31. At this time, in consideration of the coupling processing in the strip coupling unit 32 to be described later, the strip cutout unit 30 cuts out the strip images while keeping a certain amount of margin instead of cutting them out along boundaries.

After determining a content of the image processing based on the rank information of each area output by the image area processing unit 27 and the search speed of the search operation, the strip image processing unit 31 carries out the image processing on the strip images cut out by the strip cutout unit 30 and outputs them to the strip coupling unit 32.

The strip coupling unit 32 couples the strip images output from the strip image processing unit 31 to generate a coupling image corresponding to one frame, and outputs it to the frame memory 33. Although details will be given later, at this time, the strip coupling unit 32 carries out the image processing so as to smoothen the boundaries of the strip images.

The frame memory 33 temporarily buffers the coupling image output from the strip coupling unit 32.

The display processing unit 34 outputs the coupling image stored in the frame memory 33 to the display D based on the parameter.

The system controller 35 cooperates with the CPU 12 and collectively controls the processing of the blocks 21 to 34.

The I/F unit 36 cooperates with the operation input unit 15 to detect whether an input of a search operation has been made and a speed thereof, and outputs the detection result to the system controller 35.

(Operation of PVR)

Next, the operation of the PVR 100 will be described while centering on the coupling image generation processing and display processing. In descriptions below, the CPU 12 of the PVR 100 will be described as the operation subject, but the operation is executed also in cooperation with other hardware shown in FIG. 1 and the units of the video display application described with reference to FIG. 2.

(Overview of Coupling Image Display Processing)

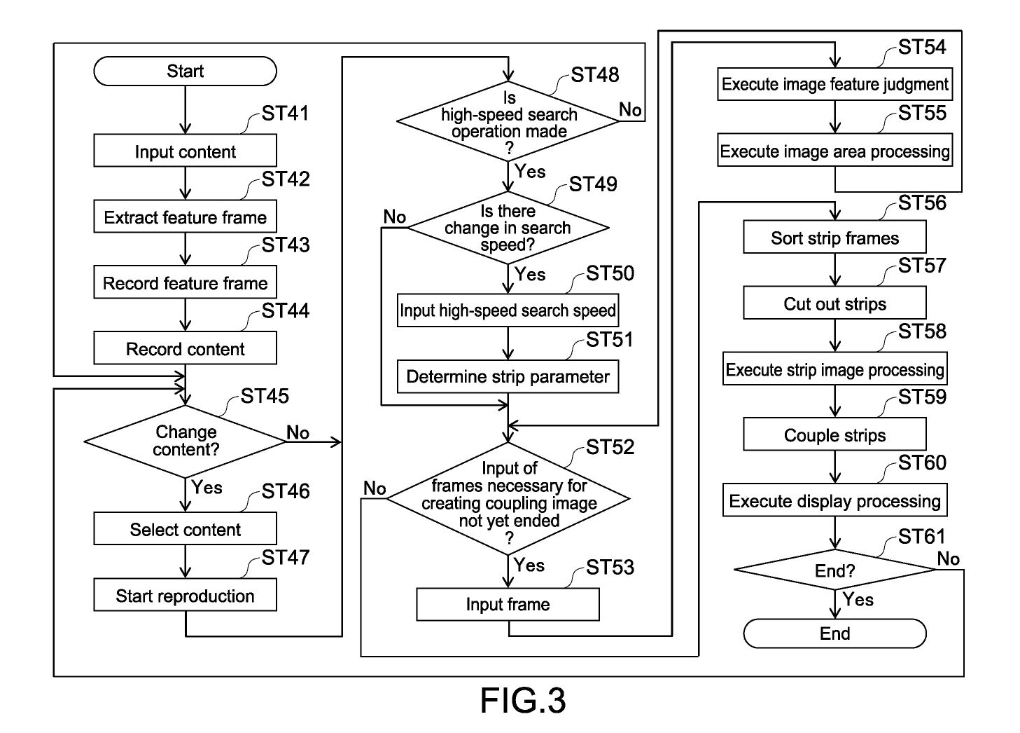

FIG. 3 is a flowchart showing a rough flow of the coupling image display processing carried out by the PVR 100 of this embodiment.

As shown in the figure, the CPU 12 first inputs a content recorded in the video signal recording unit 21 (Step 41) and extracts the feature frame from the frames of the content by the feature frame extraction unit 22 (Step 42). The CPU 12 records information on the extracted feature frame in the feature frame recording unit 23 (Step 43). The CPU 12 also records a video signal of the content from which the feature frame has been extracted in the video signal recording unit 21 (Step 44).

Subsequently, the CPU 12 determines whether the content as a reproduction target has been changed (Step 45). Step 45 is skipped when the content is not yet reproduced since the start of the processing.

Next, the CPU 12 selects a content to reproduce based on the user operation made on a content reproduction list, for example (Step 46) and starts reproducing the content (Step 47).

After the reproduction is started, the CPU 12 determines whether a high-speed search operation is made (Step 48). When the high-speed search operation is made (Yes), the CPU 12 determines whether the search speed has been changed (Step 49). When the content is reproduced for the first time since the start of the processing, Step 49 is processed as Yes. When the high-speed search speed has been changed (Yes), the CPU 12 inputs a search speed of the high-speed search operation (Step 50).

Next, the CPU 12 controls the strip parameter determination unit 28 to determine a parameter requisite for the subsequent strip frame sorting processing and the subsequent processing based on the high-speed search speed (Step 51).

Then, the CPU 12 determines whether necessary number of frames requisite for creating a coupling image, which have been determined by the strip parameter determination processing, are still being input (Step 52), and when the input is not yet ended (Yes), newly inputs a frame (Step 53).

Subsequently, the CPU 12 controls the image feature judgment unit 26 to judge (a position, shape, and size of) an object area that may cause an adverse effect on the input frame in the subsequent strip image coupling processing (Step 54). The CPU 12 also determines a plurality of rectangular areas into which the input frame is to be divided based on the distances from the center of the frame.

Then, the CPU 12 controls the image area processing unit 27 to divide the input frame for each of the judged object areas and rectangular areas and rank the degrees of importance of the divisional areas (Step 55).

The CPU 12 repeats the processing of Steps 52 to 55 for each input frame until the input of the necessary number of frames requisite for creating a coupling image is ended. Upon ending the processing, the CPU 12 controls the strip frame sorting unit 29 to sort the strip images as a cutout base of the coupling image using the feature frame information, the rank information, the strip parameter, and the high-speed search speed (Step 56).

Subsequently, the CPU 12 controls the strip cutout unit 30 to cut out strip images from different positions of the sorted frames (Step 57).

Then, the CPU 12 controls the strip coupling unit 32 to generate a coupling image by coupling the plurality of cutout strip images (Step 59).

Next, the CPU 12 controls the display processing unit 34 to display the generated coupling image on the display D (Step 60).

The CPU 12 repeats the above processing every time a reproduction target content is changed and every time a high-speed search operation is carried out on a reproduction content (Step 61).

Next, the processing described above will be described in detail.

### (Strip Parameter Determination Processing)

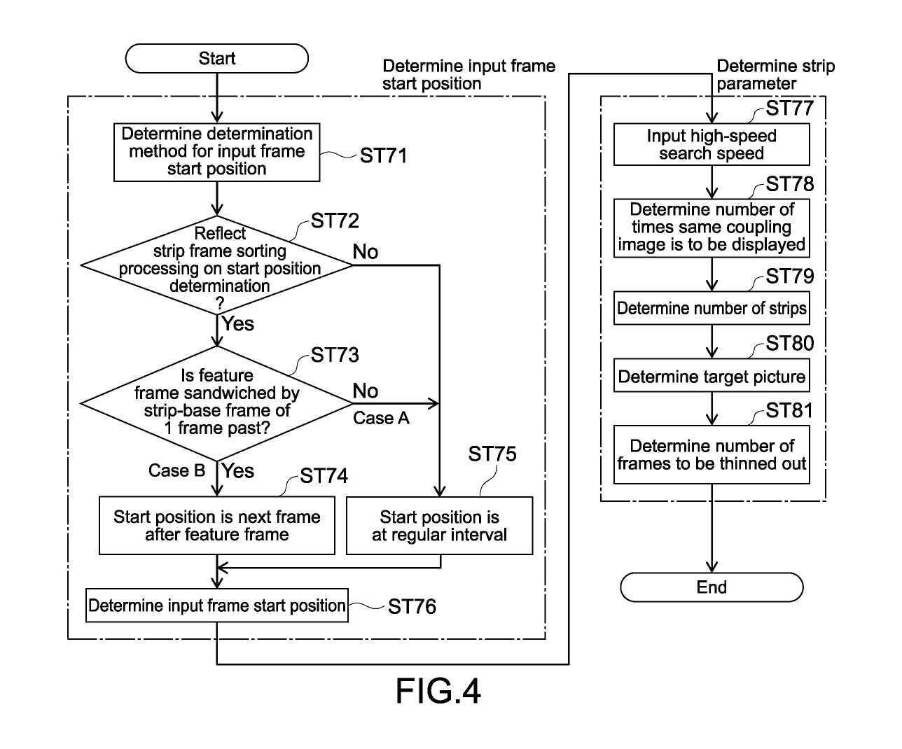

First, the strip parameter determination processing of Step 51 will be described in detail. FIG. 4 is a flowchart showing a flow of the strip parameter determination processing.

As described above, the input frame position determination processing is separated into two types of processing depending on whether to use the frame right after the feature frame as the next input frame for generating a coupling image.

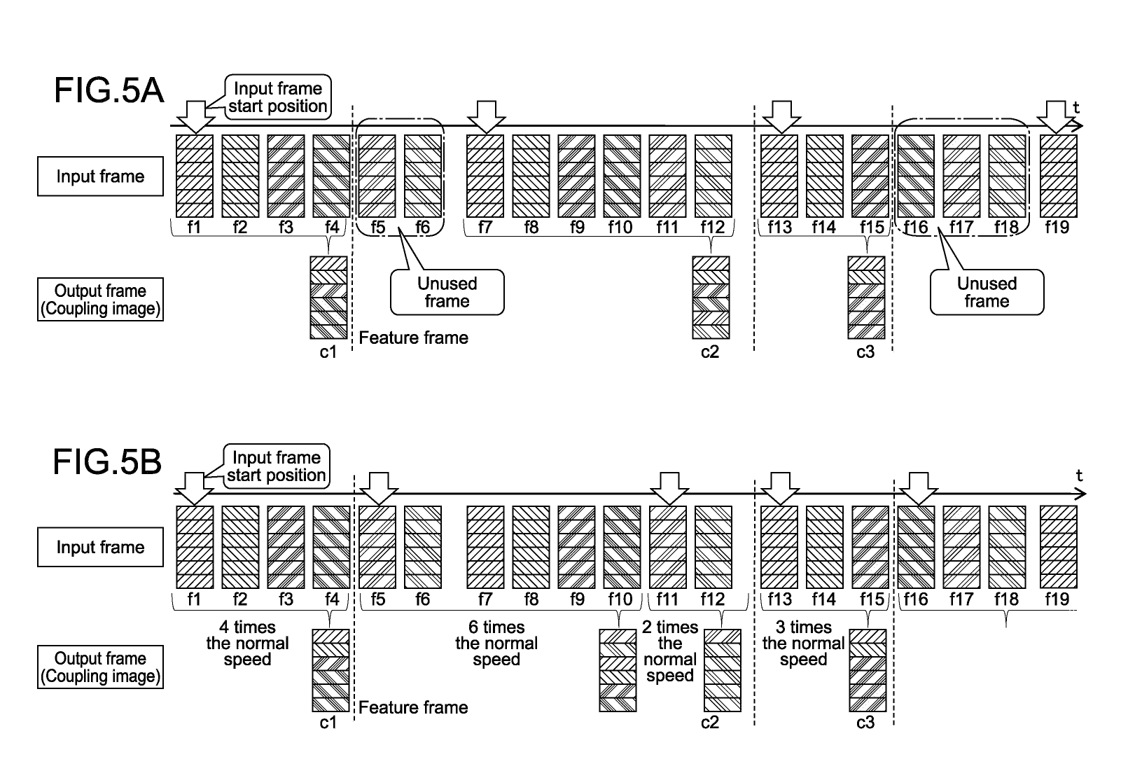

As shown in the figure, the CPU 12 first determines a determination method for a start position of an input frame in each coupling image (Step 71). As described above, in this embodiment, as the input frame position determination processing, there are a method that reflects the last processing result of the strip frame sorting unit 29 on the start position determination processing in generating the current coupling image and a method that does not reflect the processing result. FIG. 5 are diagrams showing a brief overview of the two methods of determining the start position of the input frame.

As will be described later, in the strip frame sorting processing, strip-base frames are sorted such that a feature frame is not interposed, that is, strip images of frames of different scene cuts are not mixed together in the coupling image constituted of a plurality of strip images. FIG. 5A shows a relationship between an input frame and an output frame (coupling image) in a case where the result of the frame sorting processing is not reflected or a case where the result is reflected but a feature frame is not interposed between original frames of strip images constituting a coupling image (hereinafter, referred to as Case A). FIG. 5B shows a relationship between the input frame and the output frame in a case where the result of the frame sorting processing is reflected and a feature frame is interposed between original frames of strip images constituting a coupling image (hereinafter, referred to as Case B). FIGS. 5 show examples where the number of strip images constituting a coupling image is 6.

As shown in FIG. 5A, in Case A, when each of the original frames of the strip images constituting a coupling image includes a feature frame, frames subsequent to the feature frame are not used as a cutout base of the strip images. In the example of FIG. 5A, frames f5 and f6 subsequent to the feature frame out of frames f1 to f6 are not used for a coupling image c1, and frames f16 to f18 subsequent to a feature frame out of frames f13 to f18 are not used for a coupling image c3. Since frames f7 to f12 do not include a feature frame, the frames f7 to f12 are all used for a coupling image c2.

In this case, the input frame start position becomes a frame right after the unused frame when there is a frame that has not been used for generating a previous coupling image (coupling images c1 and c3) (frames f7 and f19), and becomes a frame right after the last frame out of the used frames when all the frames have been used for generating the previous coupling image (coupling image c2) (frame f13).

On the other hand, as shown in FIG. 5B, in Case B, the frame right after the frame that has been used in the previous coupling image generation processing is used as the first frame in the next coupling image generation processing (frames f5, f11, f13, and f16). In this case, the number of frames as a base for generating the coupling image differs for each coupling image, with the result that the search speed becomes inconstant.

The CPU 12 determines whether to determine the input frame start position by either the method of Case A or the method of Case B based on, for example, a user selection or a high-speed search speed. For example, while there is an advantage that the search speed is kept constant in Case A, there is also a disadvantage that a frame that is eventually not used as a cutout base of the strip images is included. Since all the frames are used as the cutout base of the strip images unless thinned out in Case B, there is an advantage that a user hardly overlooks the image. However, since the search speed is not kept constant, the effect of outputting a search image as a coupling image of the strip images may become small.

Therefore, when determining the method by a user selection, the user makes the selection as necessary while taking the advantages and disadvantages of the above cases into account.

Moreover, when determining the method based on the high-speed search speed, since it is assumed that the user thoroughly searches scenes at a time the search speed input by the user is low (e.g., 2 to 10 times the normal speed), the CPU 12 selects Case B described above to prevent the user from overlooking the scene. On the other hand, since a certain amount of scenes are overlooked when the search speed is high (e.g., 10 times or more the normal speed), the CPU 12 places a top priority on keeping the search speed constant and selects Case A described above.

Referring back to FIG. 4, when the result of the strip frame sorting processing is selected to be reflected (Yes in Step 72) and the strip-base frame of the past one frame is sandwiching a feature frame (or is a feature frame) (Yes in Step 73), that is, in the case of Case B described above, the CPU 12 determines the input frame start position as the frame next to the feature frame (Steps 74 and 75).

On the other hand, when the result of the strip frame sorting processing is selected not to be reflected (No in Step 72) or the result is selected to be reflected (Yes in Step 72) and the strip-base frame of the past one frame is not sandwiching a feature frame (or is not a feature frame), that is, in the case of Case A described above, the CPU 12 determines the input frame start position so that the positions are at regular intervals (Steps 75 and 76).

Subsequently, the CPU 12 moves on to the strip parameter determination processing. First, the CPU 12 inputs the high-speed search speed (Step 77) and determines the number of times the same coupling image is to be displayed (number of repetitions) (Step 78).

Then, the CPU 12 determines the number of strip images to be used for the coupling image (Step 79), determines a picture type to be cutout for the strip images (Step 80), and determines the number of frames to be thinned out (Step 81).

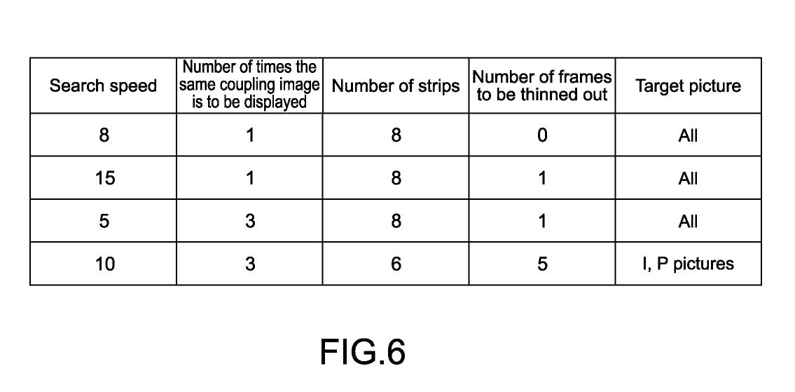

FIG. 6 is a diagram showing an example of the parameters that are determined by the processing described above.

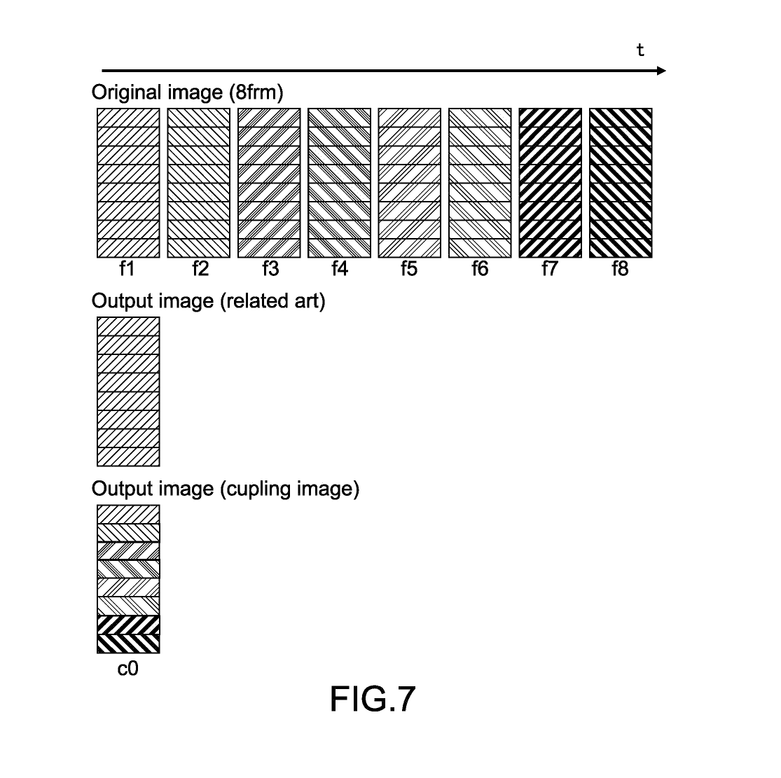

As shown in the figure, when the search speed is 8 times the normal speed, the number of times the same coupling image is to be output is 1, the number of strip images to be coupled is 8, the number of frames to be thinned out is 0, and the target pictures are all types of pictures. FIG. 7 shows an example of an original image and an output image (coupling image) in the case where the search speed is 8 times the normal speed. As shown in the figure, in the related art, when a high-speed search operation is made, an image of the very first frame is output for 8 consecutive frames. In this embodiment, however, 8 strip images obtained by dividing each frame in the horizontal direction out of the 8 consecutive frames are cut out one each from each frame to be coupled. The strip images are cut out sequentially such that a strip image at a position corresponding to the frame number is cut out in the descending order of the frames, that is, a first strip image of a first frame is cut out, a second strip image of a second frame is cut, and so on.

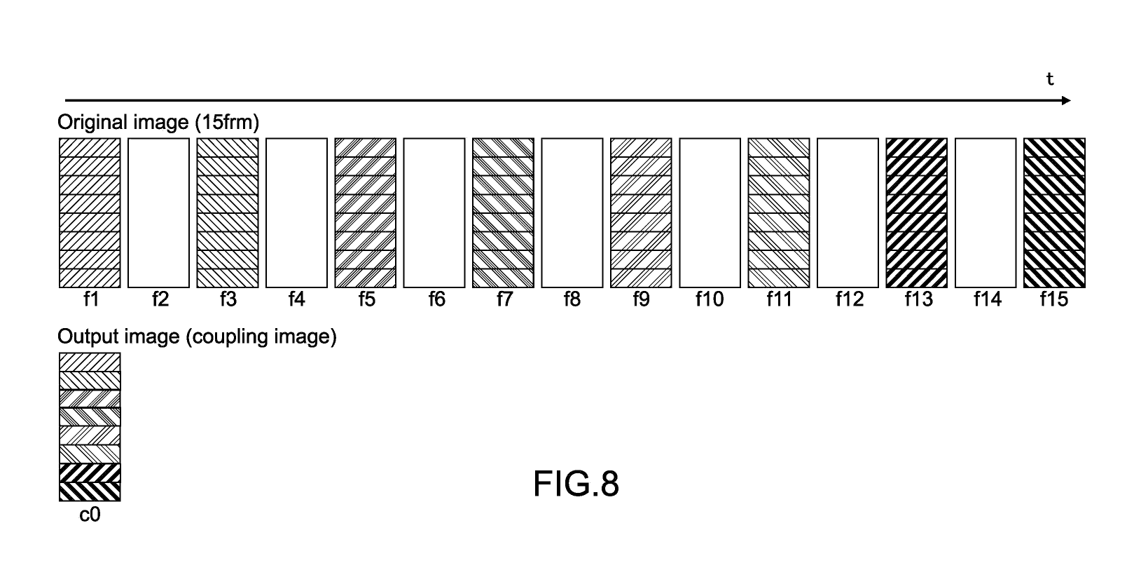

When the search speed is 15 times the normal speed, the number of times the same coupling image is output is 1, the number of strip images to be coupled is 8, the number of frames to be thinned out is 1, and the target pictures are all types of pictures. FIG. 8 shows an example of the original image and the output image (coupling image) in the case where the search speed is 15 times the normal speed.

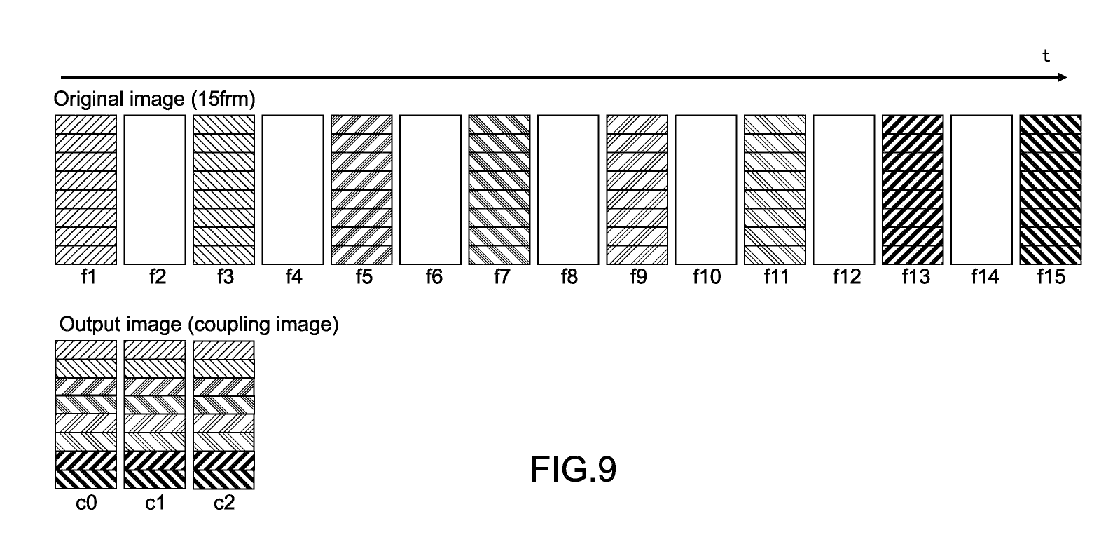

When the search speed is 5 times the normal speed, the number of times the same coupling image is output is 3, the number of strip images to be coupled is 8, the number of frames to be thinned out is 1, and the target pictures are all types of pictures. FIG. 9 shows an example of the original image and the output image (coupling image) in the case where the search speed is 5 times the normal speed.

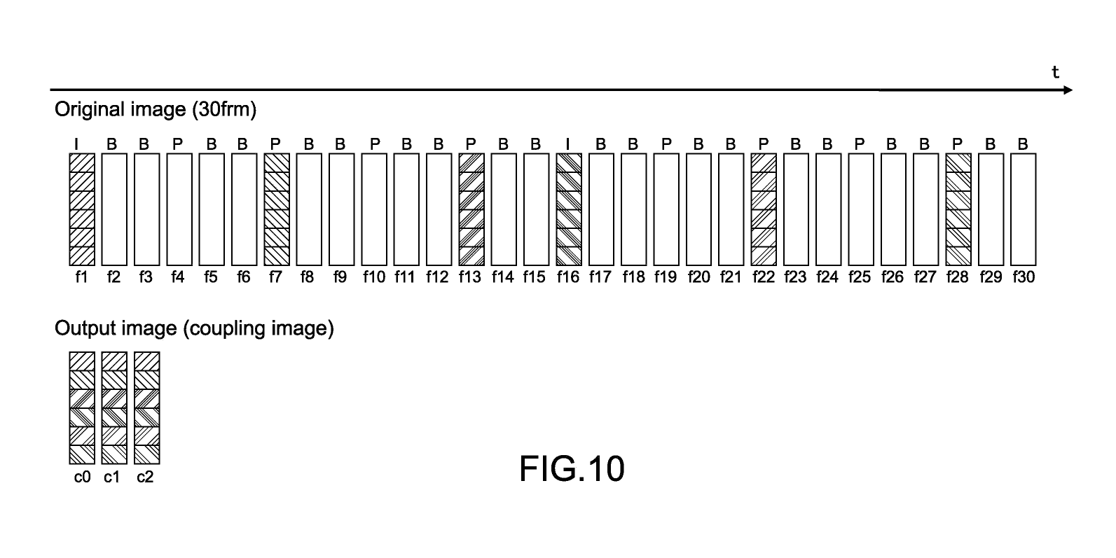

When the search speed is 10 times the normal speed, the number of times the same coupling image is output is 3, the number of strip images to be coupled is 6, the number of frames to be thinned out is 5, and the target pictures are an I picture and a P picture. FIG. 10 shows an example of the original image and the output image (coupling image) in the case where the search speed is 10 times the normal speed. The reason why only the positions of the I picture and P picture are the target is a result of taking a feasibility of mounting into account. Further, since the positions of the I picture and P picture are limited in this case, the number of a part of the frames to be thinned out (frames f13 to f15) is 2.

### (Image Feature Judgment Processing and Image Area Processing)

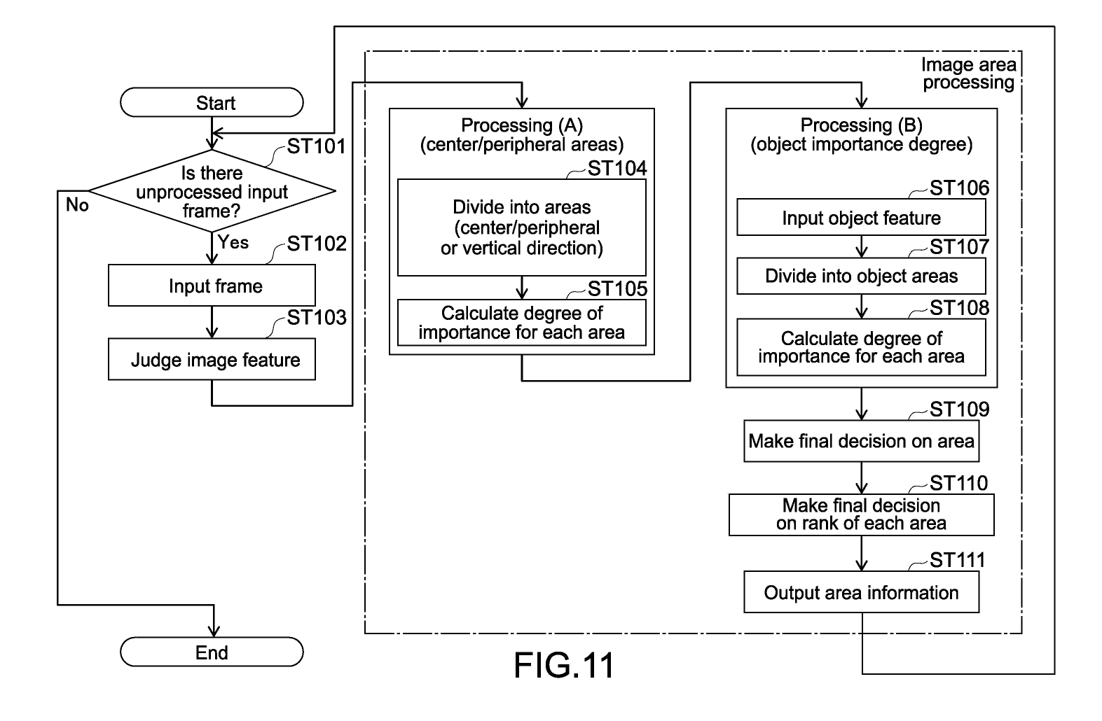

Next, details of the image feature judgment processing and image area processing of Steps 54 and 55 shown in FIG. 3 will be described. FIG. 11 is a flowchart showing a flow of the image feature judgment processing and image area processing.

As shown in the figure, the CPU 12 first judges whether there is an input frame that is not subjected to the image feature judgment processing (Step 101) and when there is, inputs a frame (Step 102) and judges a presence/absence of an image feature (object area) in the frame and a range of rectangular areas (Step 103). Also at this time, positional coordinates of the object area in the frame are detected. The positional coordinate information is detected as coordinates of four corners of a rectangle that overlap with end portions of the object in the horizontal and vertical directions and used to judge whether the object is segmentalized in the strip frame sorting processing to be described later.

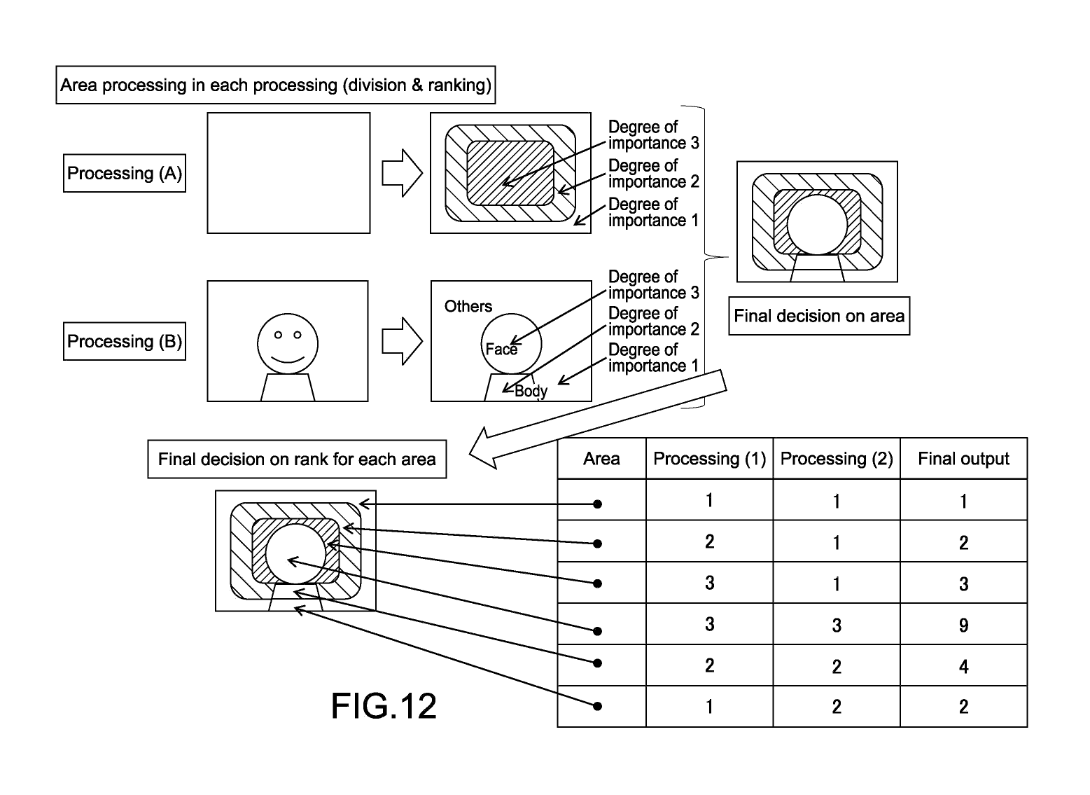

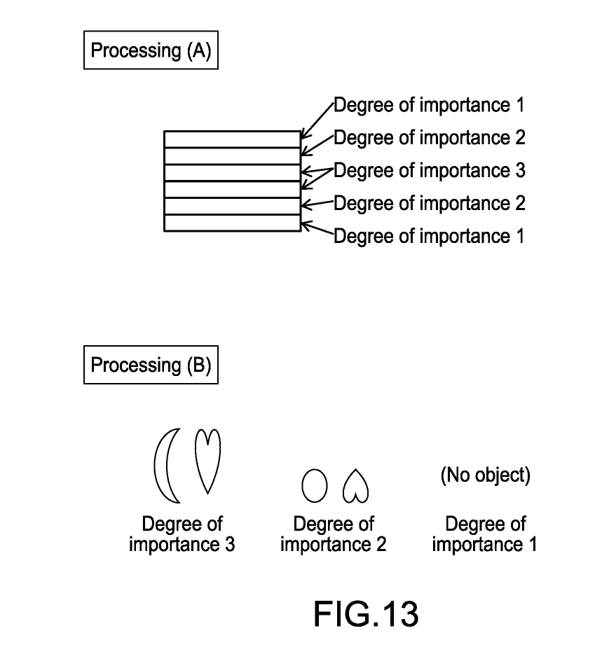

Subsequently, the CPU 12 moves on to the image area processing. First, the CPU 12 executes the image area processing related to the rectangular areas of the frame (hereinafter, referred to as processing (A)) (Steps 104 and 105), and then executes the image area processing related to the object area (hereinafter, referred to as processing (B)). FIG. 12 is a diagram schematically showing an example of the processing (A) and (B), and FIG. 13 is a diagram schematically showing other examples of the processing (A) and (B).

First, in the processing (A), the CPU 12 divides the frame into rectangular areas based on the judgment result on the range of rectangular areas (Step 104) and calculates a degree of importance of each of the divisional areas (Step 105). There are two examples for the rectangular-area division.

One of the examples is dividing a frame into a rectangular area at the center and a plurality of rectangular frame areas of different steps as shown in FIG. 12. In this example, a degree of importance of the rectangular area at the center is the highest, and degrees of importance of the rectangular frame areas around that area become lower as a distance of each area from the rectangular area at the center increases.

The other one of the examples is dividing the frame in the horizontal direction into a plurality of rectangular areas as shown in FIG. 13. In this example, the degree of importance is judged only in the vertical direction of the frame. In other words, the degree of importance becomes lower as a distance of the rectangular areas from the rectangular area at the center increases in the longitudinal direction.

Referring back to FIG. 11, the CPU 12 next inputs feature information related to the object area in the processing (B) (Step 106) and divides the frame for each object area (Step 107). Then, the CPU 12 calculates the degree of importance of each of the divisional object areas (Step 108). There are two examples for the processing for calculating a degree of importance of each object area.

One of the examples is calculating a degree of importance based on a recognition of what the object is (type/name) as shown in FIG. 12. For example, in a case where objects such as a human face, a human body (other than face), and so on are recognized, a degree of importance of the face is the highest, a degree of importance of the body is the next to highest, and degrees of importance of other objects are lowest. The objects are recognized by a general technique such as pattern matching. The image area processing unit 27 stores pattern information of each object for recognizing the objects.

The other one of the examples is calculating a degree of importance based on only a size of the object instead of recognizing what the object is as shown in FIG. 13. In this example, the degree of importance becomes higher as the object size increases.

Referring back to FIG. 11, the CPU 12 makes a final decision on the area range based on the results of the area division of the processing (A) and (B) (Step 109) as shown in FIG. 12 and makes a final decision on the degree of importance of each area based on the degrees of importance of the areas calculated in the processing (A) and (B) (Step 110). Then, the CPU 12 outputs the importance degree information of each area (rank information) to the strip frame sorting unit 29 together with area information (Step 111) and repeats the processing described above until there is no frame left as a processing target (Step 101). The area information includes positional coordinate information of the objects.

### (Strip Frame Sorting Processing)

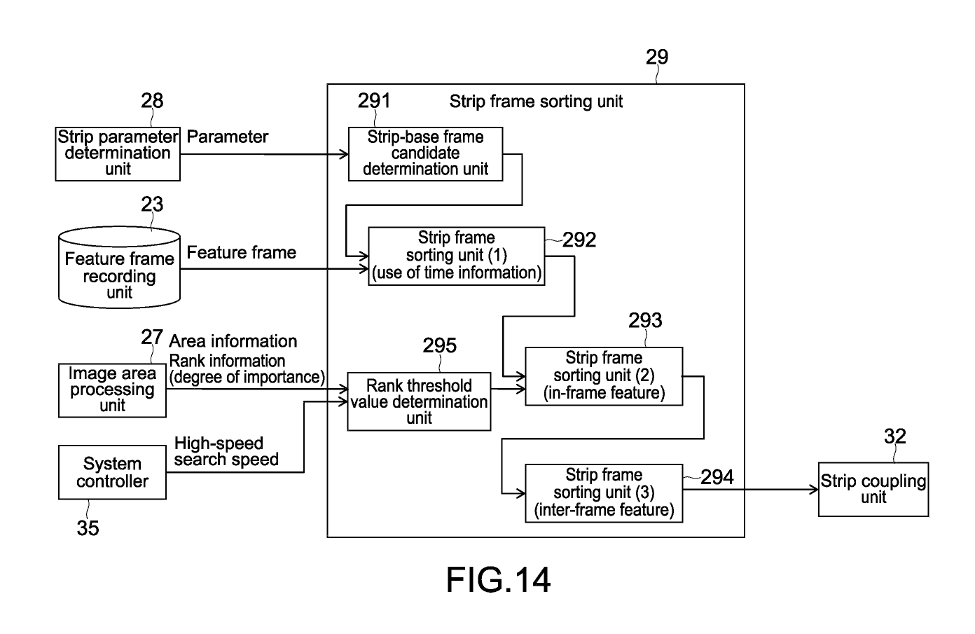

Next, details of the strip frame sorting processing of Step 56 shown in FIG. 3 will be described. FIG. 14 is a block diagram specifically showing the strip frame sorting unit 29.

As shown in the figure, the strip frame sorting unit includes a strip-base frame candidate determination unit 291, a first strip frame sorting unit 292, a second strip frame sorting unit 293, a third strip frame sorting unit 294, and a rank threshold value determination unit 295.

The strip-base frame candidate determination unit 291 receives an input of various types of parameter information from the strip parameter determination unit 28 and uses the parameter information to determine frame candidates to be a strip base.

The first strip frame sorting unit 292 receives an input of feature frame information from the feature frame recording unit 23 and uses the feature frame information (time information) to re-sort the strip-base frame candidates. This processing will hereinafter be referred to as sorting processing (1).

The rank threshold value determination unit 295 receives an input of the area information and the rank information from the image area processing unit 27 and an input of a high-speed search speed from the system controller, and determines a threshold value of the ranks of the areas to be a criterion on judging whether to re-sort the strip-base frames based on the area information, the rank information, and the high-speed search speed information.

The second strip frame sorting unit 293 additionally re-sorts the strip-base frames re-sorted in the first strip frame sorting unit 292 based on the area information, the rank information, and the information on the high-speed search speed and the determined threshold value, that is, based on the feature information of each frame. This processing will hereinafter be referred to as sorting processing (2).

The third strip frame sorting unit 294 re-sorts the strip-base frames re-sorted in the second strip frame sorting unit 293 for the last time using inter-frame feature information (degree of overlap of objects). This processing will hereinafter be referred to as sorting processing (3).

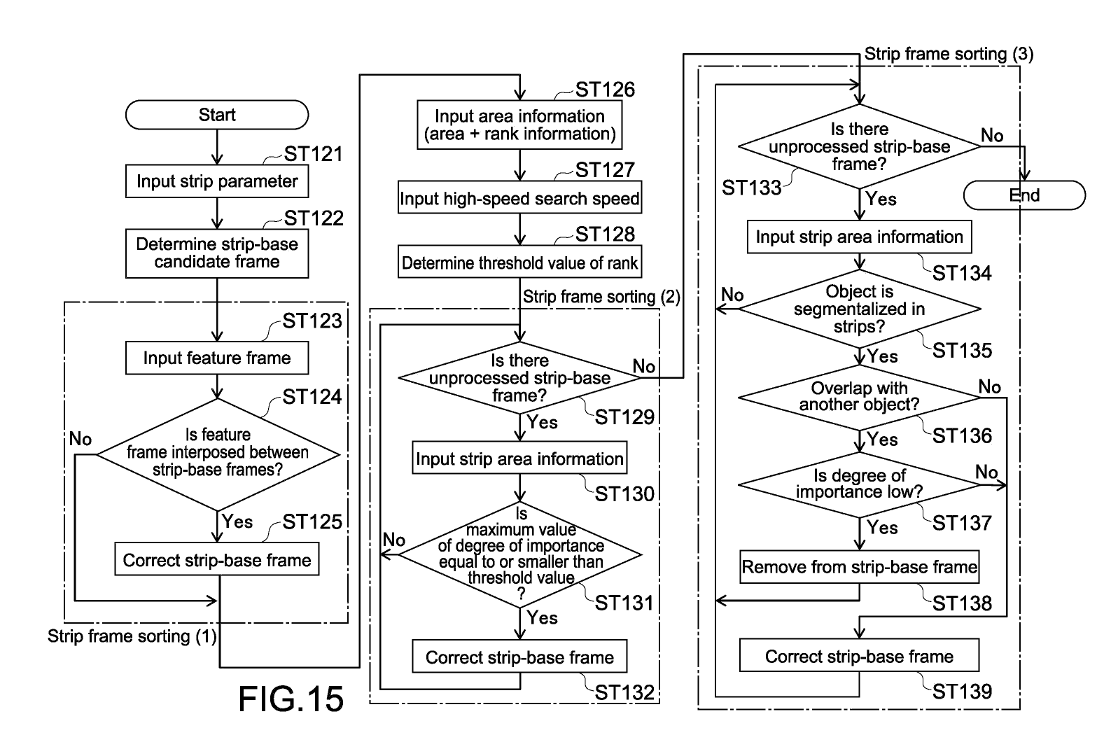

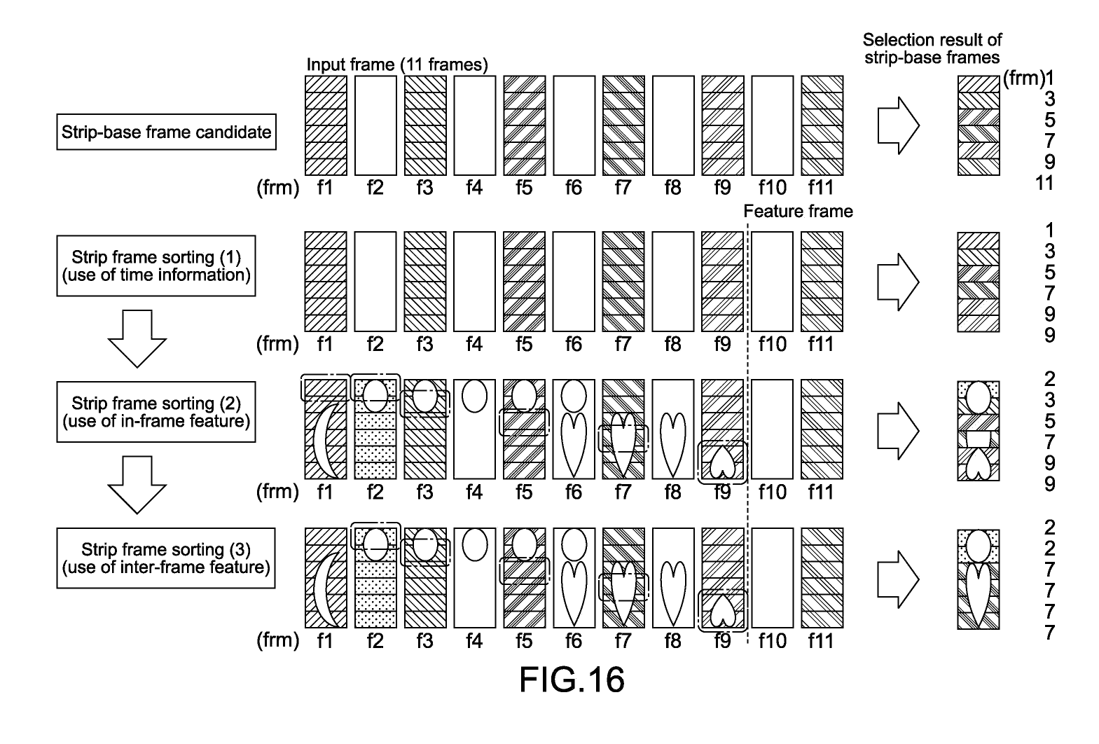

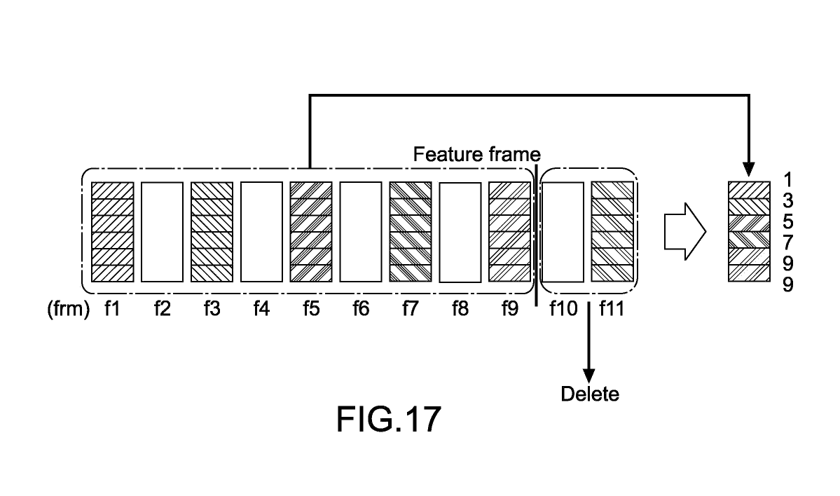

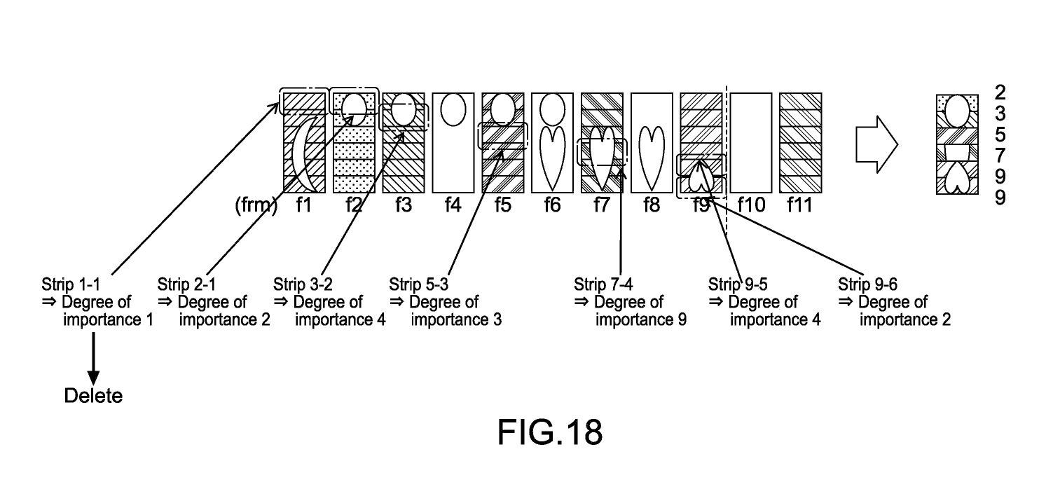

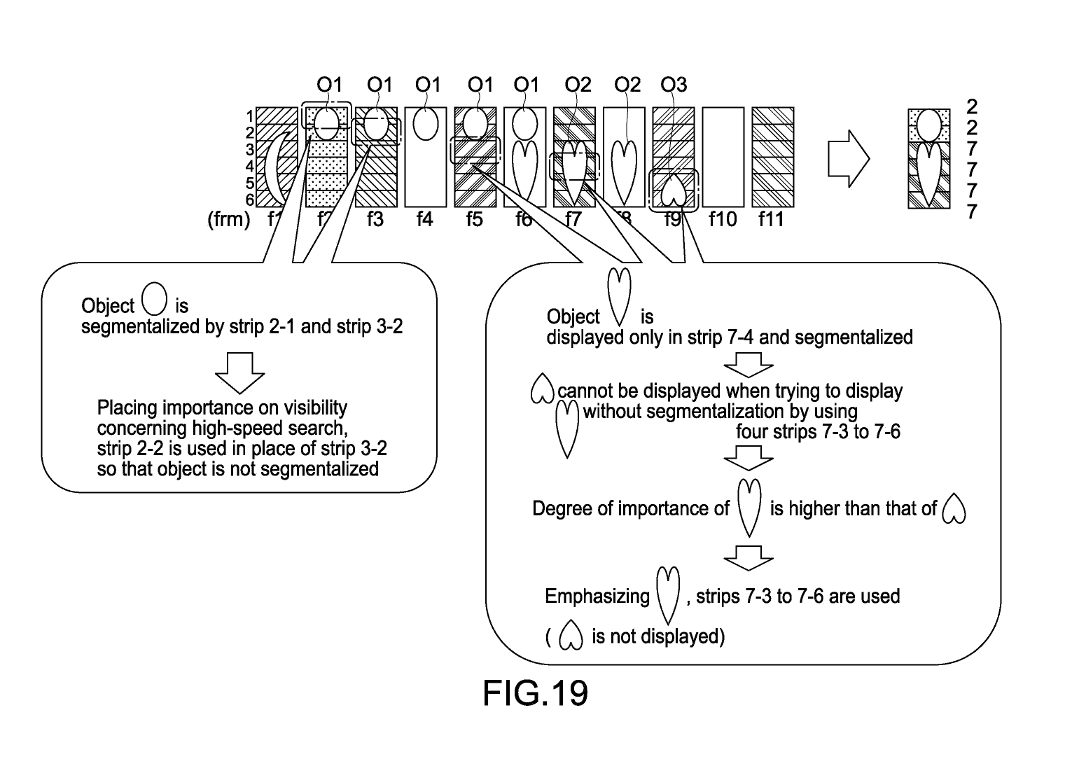

FIG. 15 is a flowchart showing a flow of the strip frame sorting processing. FIG. 16 is a diagram schematically showing an overall flow of the strip frame sorting processing. FIG. 17 is a diagram schematically showing the sorting processing (1) of the strip frame sorting processing, FIG. 18 is a diagram schematically showing the sorting processing (2) of the strip frame sorting processing, and FIG. 19 is a diagram schematically showing the sorting processing (3) of the strip frame sorting processing.

As shown in FIG. 15, the CPU 12 first receives an input of strip parameters from the strip-base frame candidate determination unit 291 (Step 121) and determines strip-base frame candidates (Step 122).

Subsequently, the CPU 12 moves on to the sorting processing (1). In the sorting processing (1), the CPU 12 first receives an input of feature frame information from the feature frame recording unit 23 (Step 123) and judges whether the feature frame is interposed between the plurality of strip-base frame candidates, that is, whether a scene change point is included in the strip-base frame candidates (Step 124).

When judging that a feature frame is interposed between the strip-base frame candidates (Yes), the CPU 12 corrects the strip-base frame candidates so that the feature frame is not interposed between the candidates (Step 125).

Specifically, the CPU 12 deletes frames positioned after the feature frame out of the strip-base frame candidates from the strip-base frame candidates. For example, as shown in FIGS. 16 and 17, the frame f11 that is positioned after the frame f9 as the feature frame is deleted out of the frames f1, f3, f5, f7, f9, and f11 as the strip-base frame candidates. When generating a coupling image from the corrected strip-base frame candidates, strip image are used one each from the frames f1, f3, f5, f7, and f9, and two strip images are used from the frame f9.

Subsequently, the CPU 12 receives an input of area information and rank information of each area from the image area processing unit 27 (Step 126) and a high-speed search speed from the system controller 35 (Step 127). Then, the CPU 12 controls the rank threshold value determination unit 295 to determine a threshold value of the ranks of the areas to be a criterion on judging whether to re-sort the strip-base frames based on the area information, the rank information, and the high-speed search speed (Step 128).

Then, the CPU 12 moves on to the sorting processing (2). In the sorting processing (2), the CPU 12 first judges whether there is an unprocessed strip-base frame candidate (Step 129) and when there is (Yes), inputs information on an area (strip area) that is to be cut out as a strip image from the strip-base frame candidate as a processing target according to the parameters (Step 130).

Next, the CPU 12 compares the strip area with the area information and the rank information and judges whether a maximum value of the degree of importance of the areas included in the strip area (object area and rectangular area) is equal to or smaller than the determined threshold value (Step 131).

When the maximum value of the degree of importance of the areas included in the strip area is equal to or smaller than the threshold value (Yes), the CPU 12 corrects the strip area to a strip area located at the same position in the adjacent frame (Step 132).

FIGS. 16 and 18 show a case where the degrees of importance of the rectangular areas are determined in the vertical direction in the horizontally-divided frame, and the degree of importance of the object area is determined based on the object size as shown in FIG. 13. In this case, since a degree of importance of a strip 1-1 of the frame f1 is equal to or smaller than the threshold value when the threshold value is set as degree of importance 1, the CPU 12 changes the strip-base frame candidate for cutting out a first strip image from the frame f1 to the frame f2 so that a strip 2-1 located at the same position in the adjacent frame f2, that has a degree of importance equal to or larger than the threshold value, is used in place of the strip 1-1.

Here, the strip 5-3 of the frame f5 includes no object area, but since the degree of importance in the vertical direction is high, the strip-base frame candidate f5 is not changed.

The CPU 12 repeats the sorting processing (2) until there is no unprocessed strip-base frame candidate left (Step 129).

Subsequently, the CPU 12 moves on to the sorting processing (3). In the sorting processing (3), the CPU 12 first judges whether there is an unprocessed strip-base frame candidate (Step 133) and when there is (Yes), inputs information on the strip areas of the strip-base frame candidate as a processing target (Step 134).

Next, after the strip areas are used as strip images, the CPU 12 judges whether an object included in other strip-base frame candidates is to be segmentalized by the strip images (Step 135).

Then, upon selecting the strip areas of other strip-base frame candidates so that the object is not segmentalized, the CPU 12 judges whether the object area overlaps another object area in the coupling image (Step 136).

The CPU 12 compares the degrees of importance between the object and the other object, removes a frame including the object having a lower degree of importance, and sets a frame including the object having a higher degree of importance as a strip-base frame candidate (Step 138).

When judged in Step 136 that the object area does not overlap another object area (No), the CPU 12 sorts, as the strip-base frame candidate, the frame including a plurality of strip areas including the entire object in place of the strip areas that are to segmentalize the object, so that the object is not segmentalized (Step 139).

Here, coordinate judgment is used for judging a presence/absence of the segmentalization. Specifically, the CPU 12 judges the presence/absence of the segmentalization based on whether the range of rectangular coordinates as the positional coordinate information of the object, that is included in the area information, overlaps the coordinate range of the strip areas.

Further, for sorting a frame including the strip areas so that the object is not segmentalized, the CPU 12 selects a strip-base frame candidate including strip areas including all the rectangular coordinate ranges.

In the example shown in FIGS. 16 and 19, for example, if the strip images are to be cut out from the strip-base frames according to the sorting processing (1), an object O1 is displayed while being segmentalized at a strip 2-1 of the frame f2 and a strip 3-2 of the frame f3 in the subsequent coupling image. In this regard, the CPU 12 changes the strip-base frame candidate of the second strip image in the coupling image from the frame f3 to the frame f2 so as to use the strip 2-2 of the frame f2 in place of the strip 3-2 so that the object O1 is not segmentalized.

Moreover, in the coupling image, an object O2 is displayed only at a strip 7-4 of the frame f7 and segmentalized. In this regard, by using four strip areas from strips 7-3 to 7-6 in the frame f7, the object O2 is not segmentalized. However, this makes it impossible for an object O3 to be displayed in the coupling image since area ranges of the object O2 and the object O3 partially overlap. In this regard, the CPU 12 compares the degrees of importance of the objects O2 and O3 based on, for example, the object sizes, and selects the frame f7 as the strip-base frame of the third to sixth strip images in the coupling image so that the object O2 having a higher degree of importance is displayed, that is, the strips 7-3 to 7-6 of the frame f7 are used.

The CPU 12 repeats the sorting processing (3) described above until there is no unprocessed strip-base frame candidate left (Step 133). As a result, the strip-base frame candidates are eventually selected as the strip-base frames.

Here, the “degree of importance” is a degree of importance related to a high-speed search by the user and is not judged based merely on an object. Even when the frame does not include an object, there are also cases where the user “wishes to start reproduction from a cut including blue sky” or “wishes to start reproduction from a cut including an empty room (e.g., wall, floor, and ceiling) with no one or nothing in it”. In this embodiment, the degree of importance is defined in the vertical direction or a center/peripheral areas considering the fact that a picture at a center of a frame is apt to become a key for the search in the sorting processing (2).

Therefore, when there is no object at the centers of all the strip-base frames, the strip area at the center is used as it is.

(Strip Cutout Processing)

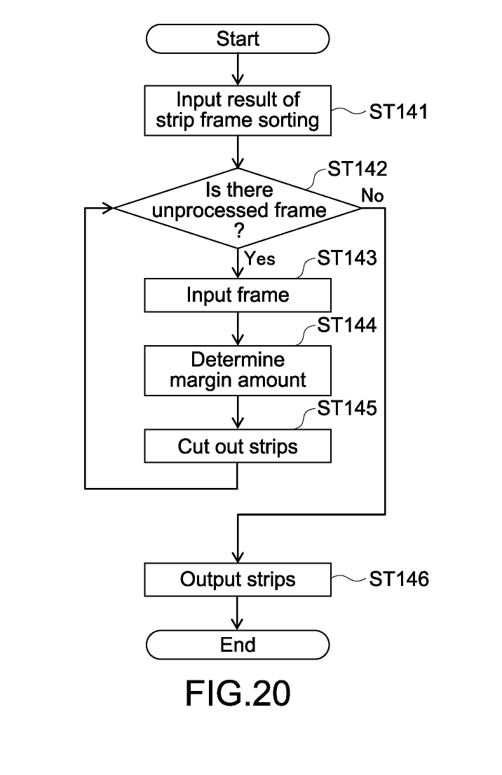

Next, details of the strip cutout processing of Step 57 shown in FIG. 3 will be described. FIG. 20 is a flowchart showing a flow of the strip cutout processing.

As shown in the figure, the CPU 12 first inputs a result of the strip frame sorting processing carried out by the strip frame sorting unit 29 (Step 141).

Next, the CPU 12 judges whether there is an unprocessed strip-base frame (Step 142) and when there is (Yes), inputs the strip-base frame (Step 143).

Then, the CPU 12 determines a cutout margin amount for the input strip-base frame (Step 144). As described above, in this embodiment, for smoothly carrying out coupling processing on strip boundaries in the strip coupling processing carried out by the strip coupling unit 32, strips are cut out while keeping a certain amount of margin instead of cutting right on the boundaries. The margin amount is set as appropriate based on, for example, the number of strip images (longitudinal length of strip images) constituting a coupling image.

Subsequently, the CPU 12 cuts out the strip images from the strip-base frame based on the input strip frame sorting result (Step 145).

The CPU 12 repeats the above processing for all the strip-base frames (Step 142), and upon ending the cutout processing for all the strip-base frames, outputs the cutout strip images to the strip image processing unit 31 (Step 146).

### (Strip Image Processing)

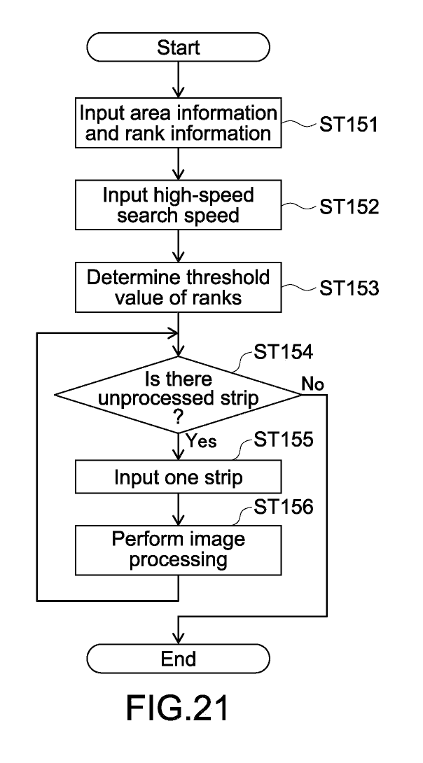

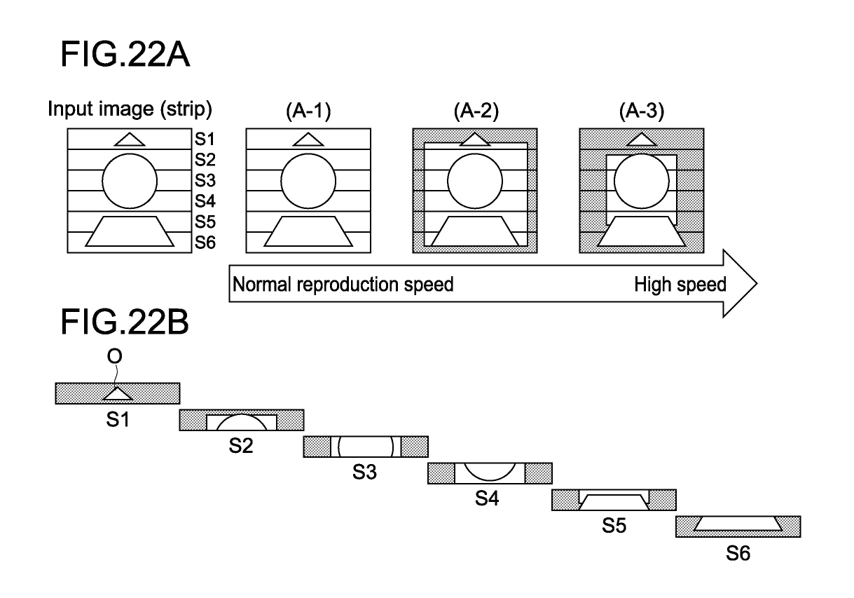

Next, details of the strip image processing of Step 58 shown in FIG. 3 will be described. FIG. 21 is a flowchart showing a flow of the strip image processing. Further, FIGS. 22 are diagrams schematically showing the strip image processing.

As shown in the figure, the CPU 12 first inputs the area information and the rank information (Step 151) and then inputs the high-speed search speed (Step 152).

Next, based on the area information, the rank information, and the high-speed search speed, the CPU 12 determines a threshold value for the degree of importance, that is, a threshold value as a criterion for judging whether to carry out image processing for image simplification to be described later, on the areas of the strip images (Step 153).

Then, the CPU 12 judges whether there is an unprocessed strip image (Step 154) and when there is (Yes), inputs one of the plurality of strip images output from the strip cutout unit 30 (Step 155).

Based on the threshold value, the CPU 12 subjects the strip images to image processing for simplifying an image in the area having a low degree of importance (Step 156). Here, the image processing for image simplification refers to, for example, airbrushing processing, color deletion processing, and substitute processing to other pixel values such as black. The CPU 12 repeats the above processing for all the strip images (Step 151).

As shown in FIG. 22A, for example, the threshold value is set to be higher as the search speed increases. Specifically, as shown in FIG. 22A(A-1), the threshold value is set low when the search speed is low, and no image in any area of the strip images is simplified. However, as shown in FIGS. 22A(A-2) and (A-3), the threshold value on the degree of importance of each area of the strip images becomes higher as the search speed increases, and the image processing is performed on the areas having a degree of importance equal to or smaller than the threshold value. In FIG. 22A(A-2), since the degree of importance of the rectangular frame area on the outermost side is the lowest as in FIG. 12, the images in the strip images corresponding to the rectangular frame area are simplified. In FIG. 22A(A-3), since the threshold value is set additionally high, the images in the strip images corresponding to the rectangular frame area more on the inner side than that shown in FIG. 22A(A-2) are simplified.

FIG. 22B shows a state of the image processing on strip images S1 to S6 in the case of FIG. 22A(A-3). As shown in the figure, since the frames having a certain degree of importance or more are sorted as strip-base frames in the frame sorting processing, the possibility of the entire area of the strip images being subjected to the simplification processing is almost 0. In the strip image S1, for example, the strip area as a cutout base of the strip image S1 has a low degree of importance in terms of a distance from the center of the frame, but since the degree of importance becomes as high as a value equal to or larger than the threshold value in an area of a triangular object O, the object O is left without being subjected to the simplification processing.

Why the area to be simplified increases as the search speed increases is based on a presupposition that a user's observing point tends to center at a center of a coupling frame as the search speed increases.

### (Strip Frame Coupling Frame)

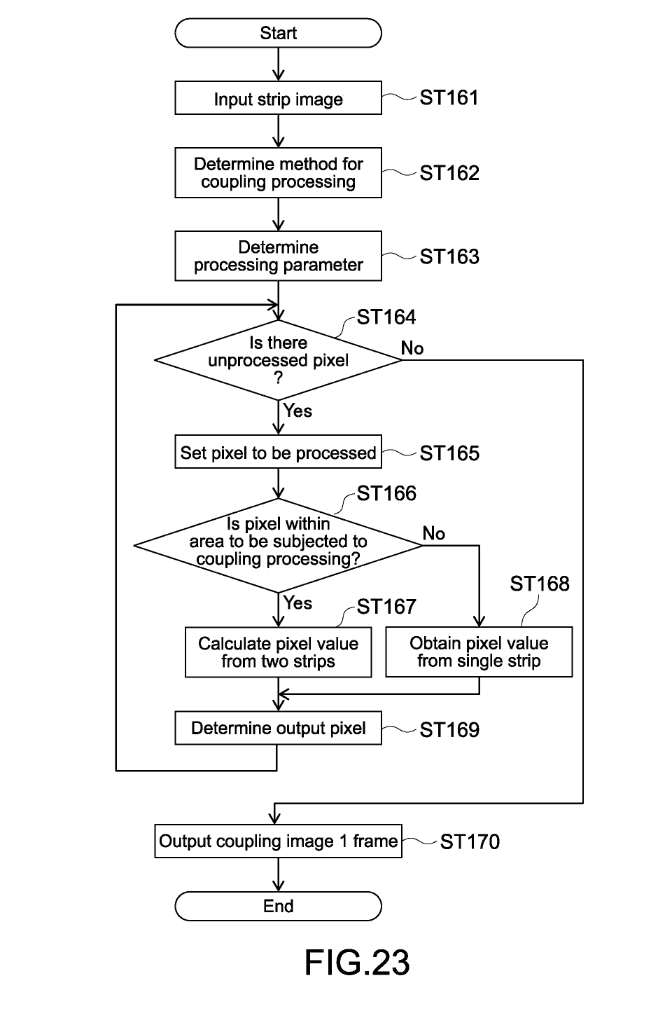

Next, details of the strip cutout processing of Step 59 shown in FIG. 3 will be described. FIG. 23 is a flowchart showing a flow of the strip cutout processing.

As shown in the figure, after the cutout, the CPU 12 first inputs strip images subjected to the image processing (Step 161) and determines a method for the strip coupling processing (Step 162).

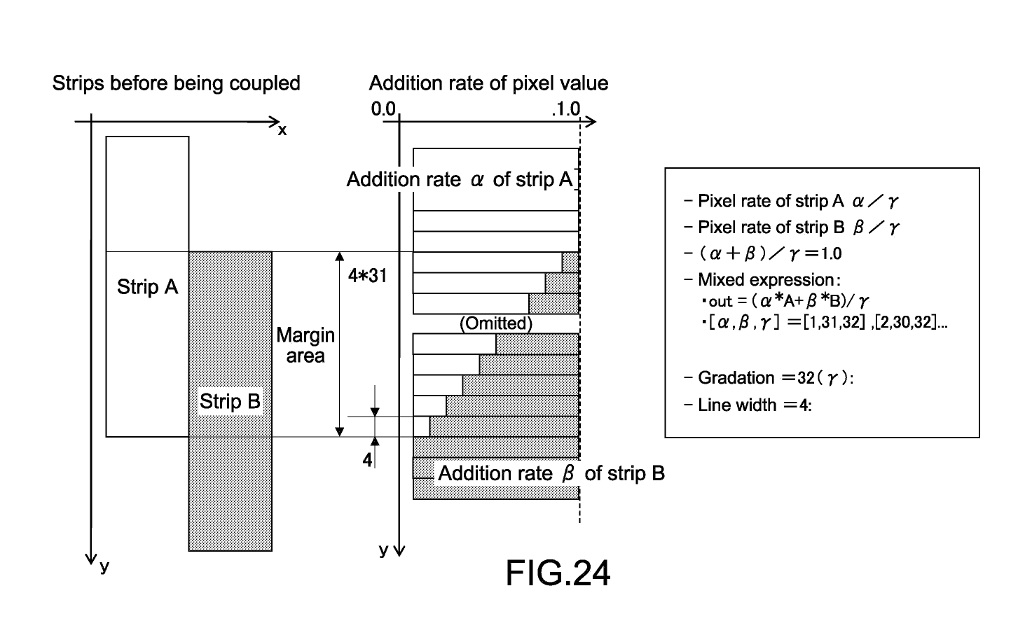

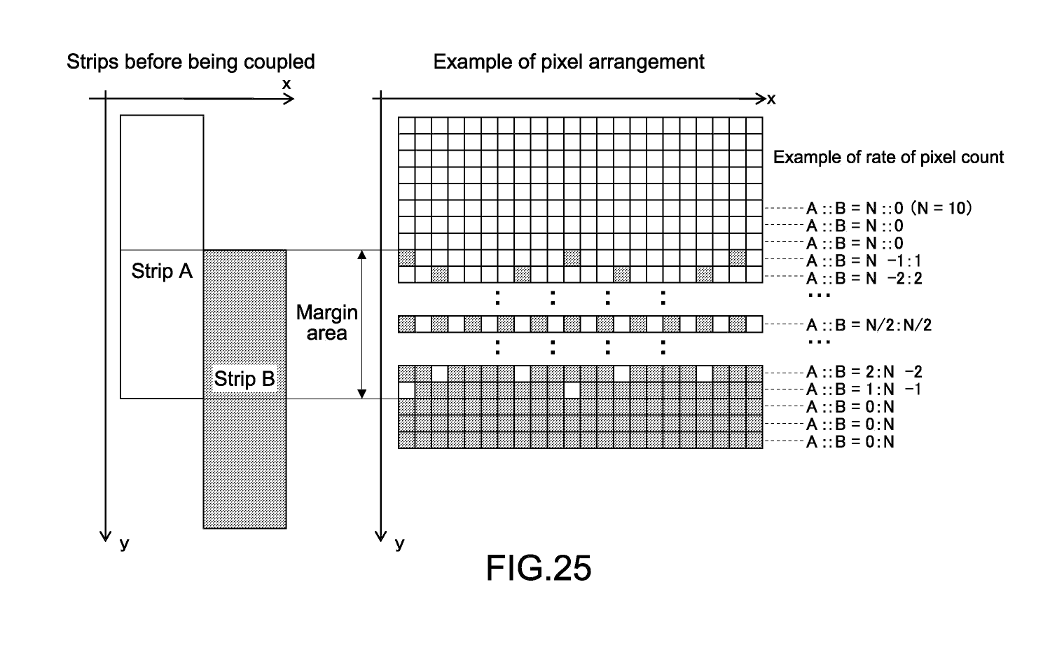

Here, in this embodiment, two types of coupling methods can be used for the strip coupling processing. FIG. 24 is a diagram showing a first coupling method, and FIG. 25 is a diagram showing a second coupling method.

As shown in FIG. 24, in the first coupling method, two strip images are coupled by adding pixels of the margin portions of the two strip images at a predetermined rate. By changing the addition rate every several lines, two strip images are coupled smoothly.

For example, when a pixel rate of a strip A is α/γ and a pixel rate of a strip B is β/γ ((α+β)/γ=1.0), values of output pixels of a coupling area is calculated by the following expressions.

out=(α*A+B)/γ

[α,β,γ]=[1,31,32],[2,30,32]

Specifically, in the coupling area, the pixel rate of the strip image A becomes higher as it gets closer to the upper strip image A, and the pixel rate of the strip image B becomes higher as it gets closer to the lower strip image B. Moreover, in the horizontal direction of the coupling area, pixels of the strip image A are arranged on the left-hand side and pixels of the strip image B are arranged on the right-hand side.

Further, in the vertical direction of the coupling area, the gradation is, for example, 32(γ), and a line width is, for example, 4. The line width is fixed in this embodiment irrespective of the number of strip images to be coupled in a single coupling image but may be changed based on the number of strip images to be coupled.

As shown in FIG. 25, in the second coupling method, pixels of a margin portion of either one of the two strip images are switched per pixel or switched every several pixels in the coupling area.

In the horizontal direction of the coupling area, the pixels may either be switched regularly or randomly. In the example shown in the figure, a case where the pixels are switched regularly and the pixels of the same strip image are made not to connect in the longitudinal and lateral directions as much as possible is shown.

In the vertical direction of the coupling image, a rate of the number of pixels of the strip image A becomes higher in the upper area, and the rate of the number of pixels of the strip image B becomes higher in the lower area. The rate of the number of pixels is changed every several lines, for example.

Referring back to FIG. 23, upon determining the method for the coupling processing, the CPU 12 determines coupling parameter of each method (Step 163). The coupling parameters are the gradation and the line width in the first coupling method and are the switching method of pixels and a unit thereof in the horizontal direction and a changing unit for the rate of the number of pixels in the vertical direction in the second coupling method, for example.

Subsequently, the CPU 12 judges whether there is an unprocessed pixel in the coupling processing of each strip image (Step 164) and when there is (Yes), sets a pixel to be processed (Step 165) and judges whether the set pixel is within the coupling area (margin area) (Step 166).

When the pixel as a processing target is within the coupling area (Yes), the CPU 12 calculates a pixel value from the two strip images using the methods described above (Step 167). On the other hand, when the pixel as a processing target is out of the coupling area (No), the CPU 12 obtains a pixel value from a single strip image (Step 168).

Then, the CPU 12 determines a final output pixel from the pixel located at a processing target position (Step 169). The CPU 12 repeats the above processing for all the pixels in all the strip images constituting a single coupling image (Step 164) and upon ending the processing for all pixels (No in Step 164), outputs one frame as a coupling image to the frame memory 33 (Step 170). Then, the coupling image output to the frame memory 33 is output to the display D by the display processing unit 34 as a search image.

### (Summary)

As described above, according to this embodiment, the PVR 100 is capable of performing control such that a coupling image obtained by coupling strip images of a plurality of frames is output as a search image when a search operation is made by a user and strip images are prevented from being cut out from the plurality of frames between which a feature frame such as a scene change is interposed in the coupling image. Therefore, the PVR 100 can prevent strip images of frames having uncorrelated video contents due to a scene change or the like from being coupled so that a coupling image unsightly for a user and whose content is difficult to understand is reproduced as a search image.

Further, by re-sorting the strip-base frames according to the degree of importance (rank) of each area in the strip-base frame candidates, the PVR 100 can prevent an important scene of a coupling image from being overlooked by a user.

### MODIFIED EXAMPLE

The present invention is not limited to the above embodiment and can be variously modified without departing from the gist of the present invention.

In the above embodiment, the video data as the processing target has been a 2D image. However, a 3D image may be used as the processing target. The 3D image used herein is in a format including a binocular disparity image (binocular image) seen from both eyes (2 observing points) of a user and depth information in a pixel unit, though not limited thereto.

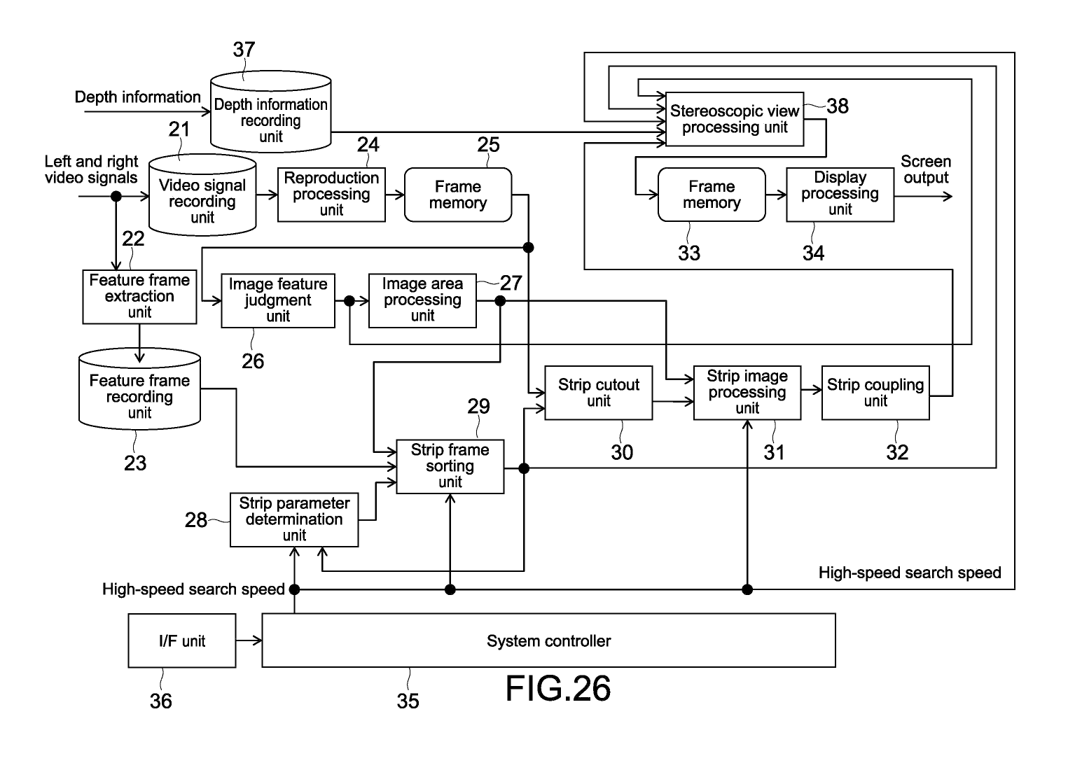

FIG. 26 is a diagram showing functional blocks of software of the PVR 100 in the case where a 3D image is used as a processing target. As shown in the figure, when a 3D image is processed, a depth information recording unit 37 and a stereoscopic view processing unit 38 are added to the PVR 100 when compared with the block diagram shown in FIG. 2. Moreover, in the figure, a video signal input to the video signal recording unit 21 is a binocular video signal representing a binocular image. In descriptions below, blocks having the same functions as those of the above embodiment are denoted by the same reference numerals, and descriptions thereof will be omitted.

The depth information recording unit 37 stores depth information input in sync with the binocular video signal.

Based on information on a strip-base frame input from the strip frame sorting unit 29, image feature information input from the image feature judgment unit 26, depth information input from the depth information recording unit 37, and a high-speed search speed input from the system controller 35, the stereoscopic view processing unit 38 converts a coupling image input from the strip coupling unit 32 into an output image most eye-friendly for the high-speed search.

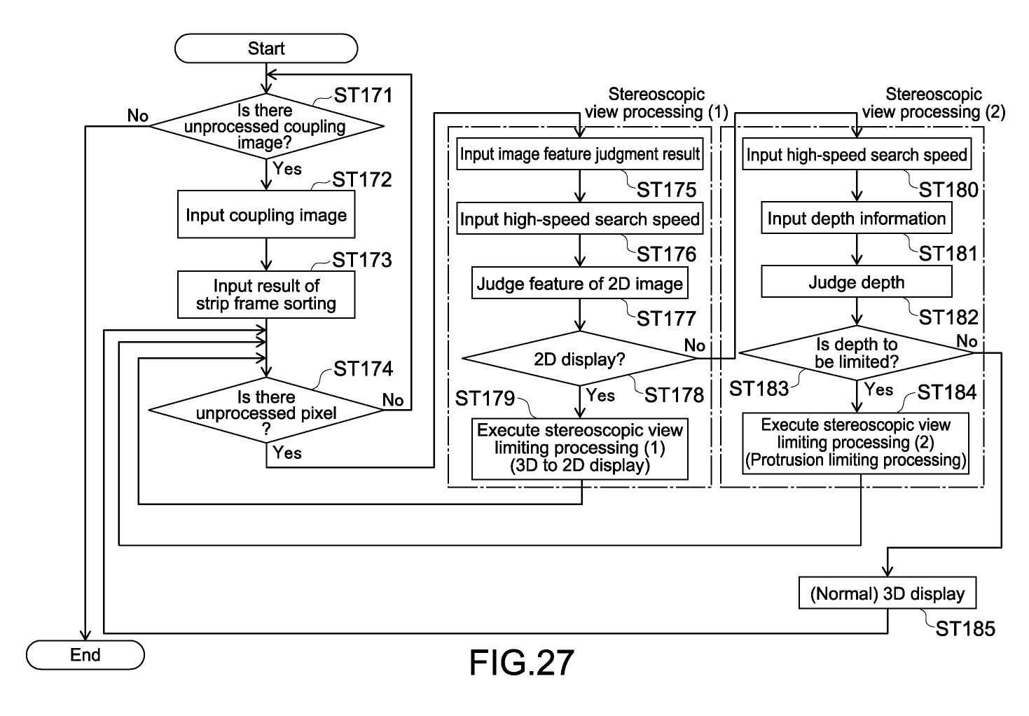

FIG. 27 is a flowchart showing a flow of display processing of the coupling image in the case where a 3D image is a processing target. In the figure, processing after a coupling image is generated as in the above embodiment is shown. Also in the figure, the CPU 12 of the PVR 100 is an operational subject.

The processing includes processing for performing 2D display on an area unsuited for 3D display (stereoscopic view processing (1)) and processing for performing, when a “distance” of an object in a coupling image is unsuited for viewing, display of a coupling image after adjusting the “distance” (stereoscopic view processing (2)). The “distance” used herein refers to whether the object seems to protrude or retracted from a display screen when seen from a user.

As shown in the figure, the CPU 12 first judges whether there is an unprocessed coupling image (Step 171) and when there is (Yes), inputs the coupling image (Step 172).

Next, the CPU 12 receives an input of sorting result information of a strip-base frame from the strip frame sorting unit 29 (Step 173).

Then, the CPU 12 judges whether there is an unprocessed pixel for the coupling image as a processing target (Step 174) and when there is (Yes), moves on to the stereoscopic view processing (1).

In the stereoscopic view processing (1), the CPU 12 first receives an input of image feature information from the image feature judgment unit 26 (Step 175) and a high-speed search speed from the system controller 35 (Step 176).

Then, the CPU 12 judges whether pixels of the coupling image are unsuited for 3D display based on the input image feature information and high-speed search speed (Step 177). For example, when the search speed is high (e.g., 10 times the normal speed) and a coupling image is to be displayed only for a moment, pixels belonging to an area including a person wearing detailed patterns or a large amount of characters included in a frame of an information program and the like are judged as pixels suited for 3D display.

Subsequently, the CPU 12 judges whether to display the target pixels in 2D display based on the judgment result (Step 178). When judging to display the pixels in 2D display (Yes), the CPU 12 converts the pixels for a 3D image into pixels for a 2D image (Step 179, stereoscopic view processing (1)). Specifically, the CPU 12 sets pixels for a left-eye image as the output pixels without using pixels for a right-eye image out of the pixels corresponding to the binocular images.

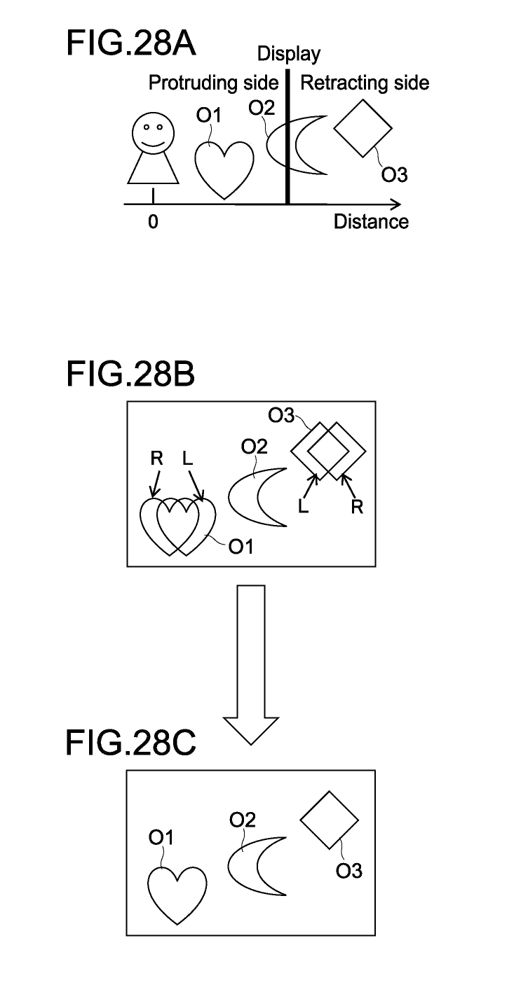

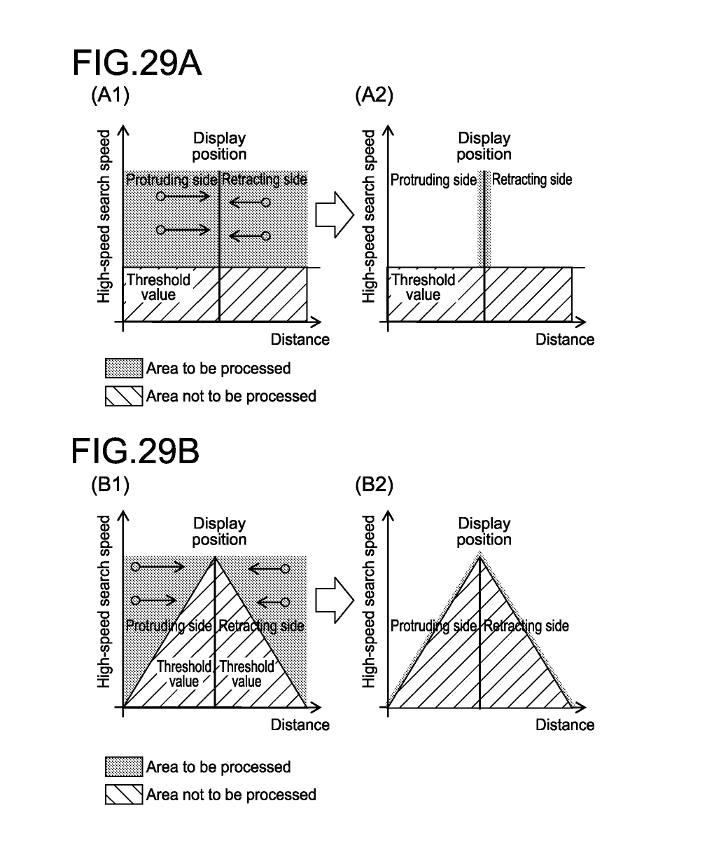

On the other hand, when judging to display the target pixels in 3D display in Step 178 (No), the CPU 12 moves on to the stereoscopic view processing (2). FIGS. 28 are diagrams showing conditions of objects that are processed in the stereoscopic view processing (2), and FIGS. 29 are diagrams schematically showing examples of the stereoscopic view processing (2).

In the stereoscopic view processing (2), the CPU 12 first receives an input of the high-speed search speed from the system controller 35 (Step 180).

Next, the CPU 12 receives an input of depth information from the depth information recording unit 37. Here, the depth information refers to a distance of each object within a coupling image from a display when seen from a user as shown in FIG. 28A. In other words, a distance of an object (object O1) that seems to protrude for a user is small, and a distance of an object (object O3) that seems retracted is large. Moreover, an object O2 appears like it is on the same plane as the display as in the case of a 2D image.

Moreover, as shown in FIG. 28B, the object O1 on the protruding side among the objects has a right-eye image on the left-hand side and a left-eye image on the right-hand side, and the object O3 on a retracting side has a right-eye image on the right-hand side and a left-eye image on the left-hand side. In the object O2 on the display, the left-eye image and the right-eye image are fully overlapped. FIG. 28C shows a state where the objects are displayed completely in 2D display after adjusting horizontal deviations of left and right images.

Referring back to FIG. 27, the CPU 12 judges whether to limit the pixels as the processing target in the depth direction based on the high-speed search speed and the depth information (Step 182). When judging to place a limit (Yes in Step 183), the CPU 12 executes depth position adjustment processing on the pixels that are protruding too much or retracting too much (Step 184, stereoscopic view processing (2)). When judging not to place a limit (No), the CPU 12 displays the pixels as a 3D image as they are (Step 185).

Specifically, when the pixels as the processing target are protruding too much or retracting too much, the CPU adjusts the pixels to move them toward the display. Specifically, this adjustment is carried out by adjusting deviation amounts of left and right images in the horizontal direction. There are two examples for the stereoscopic view limiting processing.

In the first example, when the high-speed search speed exceeds a predetermined threshold value in the depth direction judgment processing of Step 182, all the pixels in the coupling image are judged as a processing target, and the target pixels are displayed completely as a 2D image in Step 184 described above. In this case, when the high-speed search speed exceeds a threshold value as shown in FIG. 29A, all the pixels are moved toward the display. As a result, positional deviations of the objects in the horizontal direction are adjusted as shown in FIG. 28C so that the objects are displayed as a 2D image. Accordingly, since the frame that has been displayed in 3D during normal reproduction is also displayed as a 2D image during the high-speed search, a feeling of strangeness for a user is eliminated.

In the second example, in the depth direction judgment processing of Step 182, an area (pixels) having depth information equal to or larger than a predetermined threshold value, that is, an area that is protruding too much or retracting too much is judged as a processing target, and deviation amounts of left and right images in the horizontal direction are adjusted in such an area in Step 184. The predetermined threshold value varies depending on the high-speed search speed. As a result, pixels on the protruding side and the retracting side are moved closer to the display as the high-speed search speed increases as shown in FIG. 29B so that the pixels are displayed in a form close to 2D display. Therefore, in the coupling image, an area that is protruding or retracting too much is eliminated, with the result that a search image is displayed without causing a feeling of strangeness.

The strip image processing shown in FIGS. 21 and 22 and the stereoscopic view processing shown in FIGS. 26 to 29 may be executed with respect to a single normal frame instead of the strip image and the coupling image. Specifically, simplification processing of a partial image that corresponds to a search speed may be executed on a single search image that has been output when a search operation is made as in the related art, or the stereoscopic view processing may be executed when the search image is a 3D image.

Although the sorting processing (1) to (3) have been executed as the strip frame sorting processing in the above embodiment, the sorting processing (2) and (3) are not essential and the frames may be sorted only by the sorting processing (1).

Although a human face and body have been exemplified as the object in the above embodiment, the same processing may of course be executed on various other objects (including character area such as telop).

The processing described as being executed by the PVR 100 in the above embodiment and modified example can similarly be executed by various other electronic apparatuses such as a television apparatus, a PC (Personal Computer), a digital still camera, a digital video camera, a cellular phone, a smart phone, a recording/reproducing apparatus, a game apparatus, a PDA (Personal Digital Assistance), an electronic book terminal, an electronic dictionary, and a portable AV apparatus.

The present application contains subject matter related to that disclosed in Japanese Priority Patent Application JP 2010-114048 filed in the Japan Patent Office on May 18, 2010, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An electronic apparatus, comprising:
a storage configured to store video data including a plurality of frames and feature frame information related to a feature frame including a predetermined video feature among the plurality of frames;
a reproduction unit configured to reproduce the stored video data;
an operation reception unit configured to receive a search operation of a user that instructs to perform one of fast-forward and rewind of the reproduced video data at an arbitrary speed; and
a controller configured to extract, when the search operation is received, a predetermined number of candidate frames from a frame at a time point the search operation is received, sort a plurality of frames between which the feature frame is not interposed from the candidate frames, extract a partial image from each of different parts of the plurality of sorted frames, generate a coupling frame by coupling the partial images in time series, and control the reproduction unit to reproduce the coupling frame.

2. The electronic apparatus according to claim 1,
wherein at least one of the plurality of frames includes an object image indicating an arbitrary object, and
wherein the controller re-sorts the plurality of sorted frames so that the object image is not segmentalized by the extraction of the partial images.

3. The electronic apparatus according to claim 1,
wherein the controller calculates a degree of importance of each of a plurality of areas within each of the sorted frames, and re-sorts the plurality of sorted frames so that the partial images are not extracted from the area having the degree of importance smaller than a predetermined threshold value out of the areas within each frame.

4. The electronic apparatus according to claim 3,
wherein the areas are obtained by dividing each frame based on a plurality of ranges of distance from a center of each frame, and
wherein the degree of importance is set to become higher as the distance from the center to each area in each frame becomes smaller.

5. The electronic apparatus according to claim 3,
wherein the areas are obtained by dividing each frame based on an object detected from each frame, and
wherein the degree of importance is set to become higher as a size of the object detected from each frame becomes larger.

6. The electronic apparatus according to claim 2,
wherein the storage stores importance degree information indicating a degree of importance of each object that the object image represents, and
wherein the controller recognizes the object that the object image represents from the sorted frames, and re-sorts, based on the stored importance degree information, the plurality of sorted frames so that the object image indicating the object having the degree of importance that is equal to or higher than a predetermined threshold value out of the recognized objects is included in the partial images.

7. The electronic apparatus according to claim 6,
wherein the controller re-sorts, in a case where a first object image included in a first frame out of a plurality of sorted frames is not included in the coupling frame upon re-sorting the plurality of sorted frames so that a second object image included in a second frame out of the plurality of sorted frames is not segmentalized by the extraction of the partial images, the plurality of sorted frames so that an object image indicating an object having a high degree of importance out of a first object represented by the first object image and a second object represented by the second object image is included in the coupling frame.

8. The electronic apparatus according to claim 3,
wherein the controller executes predetermined image processing for simplifying an image within the partial images, that corresponds to an image of an area excluding an area within a predetermined range from a center of the coupling frame and an area having the degree of importance that is equal to or higher than the predetermined threshold value, out of the coupling frames to be generated from the partial images extracted from the plurality of sorted frames.

9. The electronic apparatus according to claim 8,
wherein the controller reduces the area within the predetermined range as the speed of one of the fast-forward and the rewind increases.

10. The electronic apparatus according to claim 1,
wherein the controller causes two of the partial images to be coupled to overlap by a predetermined amount of area, and couples the partial images by extracting pixels from the predetermined amount of area of each of the two partial images at a predetermined rate.

11. The electronic apparatus according to claim 1,
wherein the controller generates a coupling frame to be reproduced subsequent to the reproduced coupling frame based on the predetermined number of candidate frames that are extracted from frames that start with the frame right after the feature frame.

12. An image processing method, comprising:
storing video data including a plurality of frames and feature frame information related to a feature frame including a predetermined video feature among the plurality of frames;
reproducing the stored video data;
receiving a search operation of a user that instructs to perform one of fast-forward and rewind of the reproduced video data at an arbitrary speed;
extracting, when the search operation is received, a predetermined number of candidate frames from a frame at a time point the search operation is received;
sorting a plurality of frames between which the feature frame is not interposed from the candidate frames;
extracting a partial image from each of different parts of the plurality of sorted frames;
generating a coupling frame by coupling the partial images in time series; and
reproducing the coupling frame.

13. A program that causes an electronic apparatus to execute the steps of:
storing video data including a plurality of frames and feature frame information related to a feature frame including a predetermined video feature among the plurality of frames;
reproducing the stored video data;
receiving a search operation of a user that instructs to perform one of fast-forward and rewind of the reproduced video data at an arbitrary speed;
extracting, when the search operation is received, a predetermined number of candidate frames from a frame at a time point the search operation is received;
sorting a plurality of frames between which the feature frame is not interposed from the candidate frames;
extracting a partial image from each of different parts of the plurality of sorted frames;
generating a coupling frame by coupling the partial images in time series; and
reproducing the coupling frame.
